(19) United States
(12) Patent Application Publication
(10) Pub. No.: US 2013/0336590 A1
(43) Pub. Date: Dec. 19, 2013

(54) METHOD AND APPARATUS FOR GENERATING A VISUAL STORY BOARD IN REAL TIME

(71) Applicant: STMicroelectronics S.r.l., Agrate Brianza (IT)

(72) Inventors: Alexandro SENTINELLI, MILANO (IT); Luca CELETTO, UDINE (IT); Arcangelo Ranieri BRUNA, GIARDINI NAXOS (IT); Giuseppe SPAMPINATO, CATANIA (IT); Claudio Domenico MARCHISIO, ASTI (IT)

(73) Assignee: STMicroelectronics S.r.l., Agrate Brianza (IT)

(21) Appl. No.: 13/875,541

(22) Filed: May 2, 2013

(30) Foreign Application Priority Data
May 3, 2012 (IT) VI2012A000104

(51) Int. Cl. G06K 9/62

(52) U.S. Cl. CPC G06K 9/6201
USPC 382/218

(57) ABSTRACT

An embodiment includes a method and an apparatus for the generation of a visual story board in real time in an image-capturing device including a photo sensor and a buffer, wherein the method includes the consecutively performed steps: starting the recording of a video, receiving information on an image frame of the video, comparing the information on the received image frame with information on at least one of a plurality of image frames wherein the information on the plurality of image frames has previously been stored in the buffer, storing the information on the received image frame in the buffer depending on the result of the comparison, and finishing the recording of the video.

### PRIORITY CLAIM

The instant application claims priority to Italian Patent Application No. VI2012A000104, filed May 3, 2012, which application is incorporated herein by reference in its entirety.

### TECHNICAL FIELD

An embodiment relates to a method and an apparatus for the generation of visual story boards in real time, i.e., without a noticeable time lag for a user, for digital videos recorded with digital-image-capturing devices.

### SUMMARY

Since the advent of digital-image-capturing devices, like digital cameras, mobile phones, or other handhelds like personal digital assistants (PDAs), tablets, or portable computers like netbooks or notebooks, which are equipped with a photo sensor to capture digital images, digital processing of the captured digital-image frames like face detection and recognition methods, feature extraction methods, like motion detection or detection of specific types of sceneries, application of filters like anti-red eye or anti-blurring filters, and many others, has gained equal importance as processing methods related to the storing of the captured image data, like compression methods or interpolation methods.

In addition to recording digital still images, most of today's digital—image-capturing devices are also, or solely, capable of recording motion pictures as sequences of digital-image frames, called digital videos. Dedicated and inexpensive digital-video cameras have created a whole market of digital-video recording by amateur and home users. In many cases, current-day smart phones are also equipped with digital-video recording facilities.

With the wide spread use of such digital-image-capturing devices came a flood of digitally recorded videos with user-generated content (UGC), which are often made available to other users on the internet via web video-browsing services like YouTube®, social networks like Facebook®, or file-sharing techniques like BitTorrent®. The associated increase of available digital videos made it beneficial to provide the user or potential viewers with a short summary of the digital videos, which also help a user to categorize his/her videos when storing them.

In the YouTube® paradigm, videos are represented through one thumbnail, tags, and some words explaining the content. Although such an approach may be efficacious for TV or professional content, it is mostly not adaptable to the often semantically unstructured and unpredictable user-generated content of home or amateur videos. In most cases, the YouTube® paradigm also requires human interaction to provide a representative summary of the digital video.

An alternative, and now a more and more popular approach, in multimedia information retrieval (MIR) is the generation of a visual story board (VSB) from the content of the digital video. Such an approach is also known in the literature as key-frame extraction (KFE). In this paradigm, a list of the most-representative image frames is automatically extracted from the video by post-processing algorithms and stored in association with the video for later browsing. Through convenient displaying methods of the visual story boards of archived videos, it becomes easy for a user to browse a database of stored digital videos or to decide whether or not to view a video.

However, key-frame extraction as known from the state of the art is generally computationally expensive, and, therefore, carried out on computers which possess processors powerful enough to carry out the involved image post-processing algorithms within acceptable time limits. Due to the high demand of the involved algorithms in terms of compute cycles and electrical energy, key-frame extraction is generally not carried out on the image-capturing device itself such that an intermediate storage of the digital video on the image-capturing device and its download from such a device to the post-processing device are performed. A significant time delay between the recording of the digital video and the availability of the visual story board to the user is the result, and this time delay, together with additional human interaction, like transfer of memory cards or downloading operations as well as execution of the post-processing algorithms, can make the whole process of generating visual story boards tedious and unattractive to a user. When recording a digital video on a mobile phone and sending such a video to another user, e.g., via multimedia messaging services (MMS), often no costly post-processing of the digital video can be executed on any of the involved devices in order to spare battery lifetime.

Particularly, it would be desirable to a user to automatically generate a visual story board of a recorded digital video in real time, i.e., while recording the digital video, such that the visual story board is made available to the user by the image-capturing device immediately after finishing the recording of the video, i.e., without noticeable time lag for the user from finishing the recording.

The detection of changes in the content of a video may prove relevant in the context of the generation of a visual story board. The frames that are streamed during a new upcoming event are naturally considered important by an end user. Therefore, one might detect changes of the scene in the video by concentrating on the comparison between frames when conditions (either low- or high-level descriptors, or a combination of them) are changing rather than when conditions are stable.

An embodiment is a method for generating a visual story board in real time while recording a video in an image-capturing device including a photo sensor and a buffer, wherein the method includes the consecutively performed steps in the recited order:

a) receiving information on an image frame of the video;

b) comparing the information on the received image frame with information on at least one of a plurality of image frames wherein the information on the plurality of image frames has previously, i.e., before receiving the information on the image frame according to step a), been stored in the buffer;

c) storing the information on the received image frame in the buffer depending on the result of the comparison.

The above mentioned steps a), b), and c) may be cyclically performed and the previously stored information on the plurality of image frames may have been stored partially or completely in step c) of one or several previous cycles.

The image-capturing device can be a digital camera adapted to record a continuous sequence of image frames, an integrated digital camera in a mobile communication device, such as a mobile phone, smart phone, a Personal Digital Assistant (PDA), a laptop or other portable computer, a Blackberry device, a camcorder or a webcam. The photo sensor can be a charge-coupled device (CCD) or an active pixel sensor (APS), such as a CMOS APS. The buffer can be formed in a memory of the image-capturing device. The memory can be a RAM-type memory chip or the like, on-chip memory, or any memory device for digital cameras, mobile phones, smart phones, and so on as known in the art. The buffer may also be located in any kind of storage medium, localized, or distributed. Examples are memory cards like SD cards or flash memory for digital cameras, mobile phones, and smart phones, and also hard disks and flash drives for laptops, PDAs, and other portable devices, like tablets.

The above-described method may further include starting the recording of the video before step a). The recording of the video may be started by a user by pressing a button on the digital camera, operating a touch display, or remotely. Starting the recording of the video generally means starting a new video, e.g., by creating a new video file, a new image folder, or a new reference/index in a database. However, starting the recording of the video may also mean continuation of the recording of a previously started video. Thereby, a video may be recorded in a sequence of temporally separated recording sessions. A user may decide to interrupt the recording of a video in order to change location, await a new scene to be recorded, change settings on the image-capturing device, zoom or pan the capturing device, and so on. Image-capturing devices as known in the state of the art are typically equipped with the functionality of interrupting the recording of a video, even during a complete shutdown of the device, and continuing the recording at a later time. When continuing the recording of a video, the generation of a visual story board may build on contents of an existing buffer from a previous recording session of the video, and generate a visual story board for the combined recording sessions, or may scratch the contents of the existing buffer and start the generation of a new visual story board. The latter option may be selected by the user or according to a predetermined criterion.

Furthermore, the above-described method may include finishing the recording of the video. Equivalently, finishing the recording of the video may mean interrupting the recording for later resuming the recording, or the final completion of the recording process.

Information on an image frame of the video can be received by reading out the photo sensor into a microprocessor, microcontroller, or other electronic processing device, or by reading the information out of a memory buffer.

The buffer in which the information of a received image frame is stored depending on the result of the comparison can be part of any memory device for image-capturing devices as known in the art (see also above). The information may be stored in the form of data in memory according to any method known in the art or in the form of files or database entries according to any method known in the art.

The information on the received image frame to be stored in the buffer generally has the same structure and scope as the respective information on the at least one of the plurality of image frames previously stored in the buffer. It can, however, be a superset or subset of the scope of the information on the at least one of the plurality of image frames previously stored in the buffer, as long as a meaningful comparison can be carried out.

The information on an image frame may include the actual image data of the frame or parts thereof. Particularly, the actual image data of the frame may be the raw data provided by the photo sensor. Furthermore, it may include a semantic description of the data of the image frame. A semantic description may contain information on lower-level features both for audio metadata such as pitches, high-frequency sounds, speaker detection, crowd noise, or generic audio metadata/tags, or video like texture, color, and shape, frequency analysis, global-motion activity, temporal position, zoom factors, depth map, detected accelerometer activity, or activity detected from sensors located in the device, information on higher-level features like faces, objects, and text, scene, or any other information that can be derived from the image data itself, or a combination of all of the above that may define an array of semantic metadata referred to a single frame.

With an embodiment of the above-described method, key frames can be extracted from a digital video as they are being recorded. The method therefore allows for the generation of a visual story board of a video being recorded in real time, i.e., the buffer contains a temporary version of the visual story board of the so-far recorded video at any moment of the recording of the video. An additional finishing step, which is described further below, may post-process the buffer for the output of a final story board, but the above-described method of comparing newly received image frames with buffered image frames and deciding in real time whether to add, discard, or replace image frames suffices to provide a user with a real-time story board.

In an embodiment, the semantic description may include information about the spatial distribution of at least one color or color component within the image frame. The information about the spatial distribution of at least one color within the image frame may be in the form of a color histogram such as a cumulative histogram. In a further embodiment, the information about the spatial distribution of a least one color within the image frame is stored in the form of a so-called GLACE histogram description.

To extract the GLACE histogram description from the image data of an image frame, the image frame is first divided into a grid of equally sized segments, for instance in the form of rectangular pixel blocks. For each segment, the mean values of the basic colors of the color space, e.g., red, green, and blue for RGB, or Y, U, and V for YUV, and the number of saturated pixels per basic color are evaluated and stored for each basic color in a vector representing the GLACE histogram description. A pixel is considered as saturated in a basic color if the corresponding color channel of the photo sensor responds at or above a predefined value (for example, a maximum value or a value close to a maximum value). A GLACE histogram thus typically has a length given by the number of segments in the grid times the number of stored values, typically 4 or 6. The size of the grid can be pre-determined by the developer or by the image-capturing device depending on the size of the image frame in pixels, or adapted by a user or by a module which is part of the algorithm for extracting key frames from a video as described below. According to an embodiment, the GLACE histogram description of an image frame can be used as a particular type of global description of the image data of the image frame.

The GLACE histogram description, instead of pure cumulative histograms, aims at getting more information about the spatial distribution of colors within an image frame, and can significantly outperform the cumulative histogram known in the art in all tasks which involve a comparison between two image frames.

In a further embodiment, the video may include a sequence of indexed image frames and the information on an image frame may include an index. The index may particularly be given by numbering the image frames in ascending order according to the time of their capturing by the photo sensor. Thereby a video may consist of a sequence of numbered image frames wherein the number generally represents the time elapsed from the beginning of the video. Generally, image-capturing devices capture images with a fixed frequency while recording, such that the same number of consecutive image frames in a video represent the same time period in the video, i.e., the frame rate, which is the number of frames per second, remains constant throughout the video. An embodiment, however, is not limited to videos with constant frame rates, but also is applicable to videos with a varying frame rate during the video. By indexing the recorded image frames, the information received or stored on an image frame can be easily associated with the stored image data of the frame.

A visual story board may include a subset of the set of indices of the recorded image frames, representing those image frames which make up the visual story board. Storing the indices of the image frames constituting a generated visual story board instead of storing the corresponding image data therefore allows for a highly efficient and storage-space-conserving way of storing the generated visual story board.

In one further embodiment, the step of receiving information on an image frame of the video includes extracting the information from the data of the image frame. The data of the image frame may include the actual pixel data, representing the basic color values or luminance and possibly layer information like layer number and opacity, and metadata including high-level information like, e.g., dimensions, color palette, number of layers, data such as MPEG, JPEG, TIFF, PNG, etc., used color space, GPS position tags, face-recognition tags, zoom factors, color depth, information from a motion detector of the image-capturing device, or similar information known in the art. An image frame consisting of several layers typically includes basic color values or luminance values for each layer and each pixel. Extracting the information on an image frame from the data of the image frame may include decompressing or decoding the pixel data using information from the metadata. It may furthermore include using image data of neighboring image frames, particularly image frames earlier in the sequence. It may also include combining image data from two neighboring image frames according to an interlace method. An embodiment of the above-described method uses the above-described GLACE algorithm to extract information on an image frame and to store the extracted information in the form of a GLACE histogram description. Alternative or additional methods may employ face-recognition techniques, motion-detection techniques, cumulative color histograms, or other techniques known in the art for extracting information from an image frame. It is also possible to extract metadata information from the audio that indicates, for example, audio discontinuities such as peaks, high-frequency sounds, and to include such metadata information in the information on the image frame.

In a further embodiment, the step of starting the recording of the video includes receiving and storing information on at least one image frame of the video in the buffer. When starting the recording of a new video, a new buffer may be created in the memory of the image-capturing device. The buffer may have a predetermined size N_{F} in terms of a number of image frames whose information can be stored, e.g., N_{F}=30. The size of the buffer may be predetermined by user input, device settings, or the manufacturer of the device. The buffer size may be fixed during the capturing of a video or may be varied. At the beginning of the recording of a new video, the buffer is typically empty. When the recording of a new video is started, information on at least one image frame of the video will be stored in the buffer. The at least one image frame of the video need not be the first image frame recorded for the video, but can also be any subsequent image frame. The system may store information on more than one image frame in the buffer when starting the recording of the video. More specifically, the system, i.e., the image-capturing device, may store information on Nₐ image frames in the buffer, where 1≦Nₐ≦N_{F}. In an embodiment, the system may collect information on image frames and store them in the buffer until the buffer has filled up to its predetermined size N_{F}.

The system may collect information on image frames with a predetermined sampling rate S_{R}, wherein the sampling rate S_{R} specifies after how many candidate image frames the information on one image frame is stored in the buffer. For example, information on an image frame may be stored in the buffer every 10 candidate image frames. A candidate image frame may be any recorded image frame or those recorded image frames which have passed through a pre-filtering process wherein the pre-filtering process may discard image frames according to a pre-determined criterion, such as almost monotone image frames, image frames of bad quality, blurred frames, or similar. The pre-determined criterion may be set by the image-capturing device, the user, or the manufacturer. Examples for possible frame filters for the pre-filtering process are given further below. The sampling rate S_{R} may be constant throughout the recording of the video or may be a function of the index of the candidate image frame, the number of candidate image frames recorded so far, or the time elapsed since the beginning of the video. Any kind of monotonic or non-monotonic function may be applied. The function may be pre-determined by the user or the manufacturer or may be selected by an embodiment of an algorithm according to a pre-determined criterion.

The size of the buffer N_{F} may be variable during the recording of the video and may depend on the number of recorded image frames, the number of detected scenes, a detected motion activity, a detected accelerometer activity or activity detected from sensors located in the device, or similar. A new scene may be detected by detecting an event, like for instance the interruption and resuming of the recording process by a user, a motion activity detected by motion sensors of the image-capturing device, an acceleration detected by accelerometers of the image-capturing device, a sudden change of brightness of the recorded image frame, a sudden change of the captured faces, detected via face-recognition techniques or from face-recognition tags, a sudden change of location, e.g., detected from GPS position tags, or similar. A scene may for instance be defined as a coherent episode in the video, whose end is marked by any of the above-mentioned events. Particularly, detection of any of the above-listed events may trigger the enlargement of the buffer by a pre-determined amount of image frames to a new size N_{F}′. The step size for the enlargement may be pre-determined by the user or the manufacturer or may be determined by an embodiment of a method according to a pre-determined criterion. More particularly, the step size may be a function of the number of recorded image frames or the number of detected scenes. Any monotonically increasing function may be allowed (see also discussion further below).

After the buffer has been filled up to the pre-determined number Nₐ of image frames whose information is stored in the buffer, a similarity matrix of dimension N×N may be calculated as described further below. The dimension N may be in particular equal to Nₐ.

Storing information on recorded image frames in the buffer based on a sampling rate S_{R} as described above allows for a supervised arithmetical temporal sampling. By selecting a specific function for the sampling rate S_{R} depending on the content or type of the recorded video, the generated visual story board can be made to better reflect the natural evolution of the story of the video. By way of example, landscape scenes with little motion may be sufficiently represented with a low sampling rate while human or animal portraits as well as scenes with a lot of motion such as sport events may benefit from a significantly higher sampling rate. Together with the buffer update based on similarity matching described further below, a visual story board which is representative of the content of the recorded video can be generated.

According to an embodiment, the step of comparing the information on the received image frame with information on at least one of the plurality of image frames includes similarity matching among the semantic description of the received image frame and the semantic description of the at least one of the plurality of images frames, wherein:

the similarity matching produces at least one numerical value representing the degree of similarity of the semantic descriptions of the received image frame and the at least one of the plurality of image frames;

the result of the comparison includes a logical value representing whether the corresponding image frames possess at least a pre-determined degree of similarity; and

the comparison determines the logical value by comparing the at least one numerical value with at least one pre-determined threshold representing the pre-determined degree of similarity, wherein, in particular, the at least one pre-determined threshold is adapted during the recording of the video.

A purpose of the performed similarity matching between the semantic descriptions of two image frames is to determine whether the two corresponding image frames possess a pre-determined degree of similarity. The numerical value representing the degree of similarity of the semantic descriptions of the two image frames can be calculated by a pre-determined algorithm depending on the type of the semantic description. If the semantic description contains color histograms, more particularly the GLACE histogram description, the numerical value can be calculated based on the distance of the histograms (see further below). The calculation of the numerical value may also be based on the detection of common features in both semantic descriptions, for instance the presence of the same person in both image frames or the same motion detected in both image frames.

The logical value resulting from the comparison can be TRUE or FALSE depending on whether the corresponding image frames possess at least a pre-determined degree of similarity or not, respectively. The logical value is determined by comparing the at least one numerical value with at least one pre-determined threshold representing the pre-determined degree of similarity. In the simplest case, it can be tested whether a scalar numerical value is larger or smaller than a scalar pre-determined threshold. More complicated logical expressions, also involving more than one numerical value or more than one pre-determined threshold or other logical operators, can be tested and the result set according to the result of the logical expression. If the logical expression evaluates to TRUE, i.e., if the corresponding frames possess at least the pre-determined degree of similarity, then the logical value is set to TRUE, else to FALSE.

By determining at least one numerical value according to an embodiment of the above-described method, it becomes possible to quantify the similarity of two image frames. Information on image frames which according to the similarity matching are ‘too similar’, i.e., whose logical value is TRUE, may be discarded from the buffer, thereby reducing the redundancy of information in the buffer and with it the redundancy in the generated visual story board (see further below).

Equally, if it is determined that the received image frame is ‘too similar’ to at least one of the plurality of image frames, information on which is stored in the buffer, the information on the received image frame can be discarded without further processing. This will commonly be the case if an extended scene with many highly similar candidate image frames is recorded by the image-capturing device. Instead of adding information on an image frame to the buffer, which strongly resembles the information on the image frame most recently added to the buffer or any previously added image frame, the information is simply discarded without further processing. This can help to reduce the number of key frames in the visual story board and strongly reduces redundancy in the buffer.

The at least one pre-determined threshold may furthermore be adapted during the recording of the video. This may be particularly relevant with respect to the many different ways a user may record a video and the many semantic aspects that the algorithm can consider. For instance, some users may tend to pan and zoom much more frequently than others when recording a video resulting in a reduced similarity of the recorded frames even of the same scene. By adaptation of the at least one pre-determined threshold by the image-capturing device, e.g., depending on the detection of increased movement of the device or zoom activity or low luminance, e.g., in an indoor environment, unnecessary storage of redundant information on image frames in the buffer can be avoided and the story board can be made more compact.

According to a further embodiment, the information on the received image frame can be stored in the buffer if the determined logical value is FALSE. In that case, as described above, the received image frame does not possess at least a pre-determined degree of similarity with the at least one of the plurality of image frames, e.g., the image frame whose information has been added most recently to the buffer. In such a case, the information on the received image frame can be either simply added to the buffer or replace the information on the at least one of the plurality of image frames, as described further below.

In an alternative embodiment, the step of comparing the information on the received image frame with information on at least one of the plurality of image frames may include:

pairwise similarity matching among the semantic descriptions of the received image frame and the plurality of image frames, wherein the similarity-matching produces at least one numerical value representing the degree of similarity of the semantic descriptions of the respective pair of image frames;

storing the produced at least one numerical value in a similarity matrix, wherein each matrix element (i, j) of the similarity matrix is given by the at least one numerical value resulting from a similarity matching of the image frames with list indices i and j selected from an ordered list consisting of the plurality of image frames and the received image frame; and

determining an image frame with list index k from the ordered list consisting of the plurality of image frames and the received image frame, which, if removed from the similarity matrix, optimizes the similarity matrix according to a pre-determined criterion.

The step of storing the information on the received image frame in the buffer depending on the result of the comparison may include replacing the information on the determined image frame with list index k in the buffer by the information on the received image frame unless the determined image frame with list index k is the received image frame itself.

In an embodiment, the similarity matching can be done in the form of a similarity matrix containing the results of pairwise similarity matching among the semantic description of two image frames. To that end, a list consisting of the received image frame and the plurality of image frames, information on which has been previously stored in the buffer, is formed in an arbitrary order, e.g., ordered by increasing index or time stamp of the corresponding image frame. The list may be formed either directly in the buffer, for instance by the existing order of storing the information on the image frames in the buffer, or in the memory of the image-capturing device.

The similarity matrix can then be built by storing the results of pairwise similarity matching between the semantic description of the image frame with list index i and the semantic description of the image frame with list index j in the matrix element (i, j) of the similarity matrix. According to one possible embodiment, the elements of the similarity matrix for those pairs of image frames, information on which has already previously been stored in the buffer, have already been calculated by the described algorithm at an earlier stage: either by calculating the similarity matrix for all buffer frames, i.e., the image frames, information on which has been stored in the buffer, in one go, triggered by an event like the filling up of the buffer of a fixed size, e.g., when starting the recording of the video, or by stepwise adding lines and rows to an existing similarity matrix every time information on a new image frame gets added to the buffer. Particularly, the building of a similarity matrix by similarity matching may be done once the buffer contains information on at least two image frames. Building the similarity matrix step-by-step every time an image frame gets added conserves computing resources. Also it is clear from the construction of the similarity matrix that the similarity matrix is a symmetric matrix. Therefore, less than half of the matrix elements need to be calculated. The similarity matrix can be stored in the buffer itself or in the memory of the image-capturing device and may be discarded after finishing the recording of the video.

According to an embodiment, a previously calculated similarity matrix for the buffer frames can be extended by the addition of the received image frame. The dimension of the similarity matrix is thus temporarily increased from N×N to (N+1)×(N+1), mimicking a buffer which is temporarily increased by the addition of the information on the received image frame.

In the following step, the image frame with list index k from the ordered list consisting of the plurality of image frames and the received image frame is determined, which, if removed from the similarity matrix, optimizes the similarity matrix according to a pre-determined criterion. The pre-determined criterion may be, in particular, the maximization of the global sum of the similarity matrix from which line number k and row number k have been removed, wherein the global sum is defined by the sum over all remaining elements of the similarity matrix. An alternative pre-determined criterion may be given by finding the minimum of the similarity matrix, excluding its diagonal (which corresponds to similarity matching of an image frame with itself), i.e., the smallest matrix element (i, j). Here, as above, it is assumed without limitation that the result of each pairwise similarity matching is a non-negative scalar value, particularly a floating number between 0 and 1. More evolved algorithms based on pairwise similarity matching producing a plurality of numerical values are, however, possible.

Once the smallest matrix element (i, j) is found, it can be determined according to a pre-determined criterion whether the image frame with list index i or the image frame with list index j shall be removed from the similarity matrix. The pre-determined criterion can be given by one or more of the following list: remove the older of the two frames, where the older means recorded earlier, remove the older of the two frames unless the older frame is not the oldest frame among the buffer frames, keep the sharpest frame, i.e., remove the less-sharp frame, wherein the sharpness is determined by a quality score based on frequency analysis of the image data of the corresponding image frame, keep the sharpest frame, wherein the sharpness is determined by a quality score based on global-motion activity in the image frame, keep the frame which is closer to the above-described arithmetical sampling rate, keep the frame which shows a face through face-detection tags, remove the frame wherein a red-eye algorithm has detected red eyes, keep the frame which shows a pre-determined, possibly by the user, identified face, or combinations thereof.

Once the image frame with list index k to be removed from the similarity matrix has been determined by the described algorithm, the algorithm determines whether the image frame with list index k is the received image frame itself. If this is not the case, the information on the determined image frame with index k can be replaced by the information on the received image frame. Thus, the temporarily extended similarity matrix can be shrunk back to dimension N×N by removing the line and row with index k and the current size of the buffer remains unchanged.

An embodiment of the method described above not only allows for the information on the newly received image frame to replace the information on the image frame added most recently to the buffer, but also the information on any image frame added earlier to the buffer. Thus, the overall size of the buffer and the visual story board can be kept constant and the most representative image frames may be selected. The overall size of the buffer and the visual storyboard can be also increased following a generic monotonically increasing curve that follows the timeline of the video. The longer the video becomes, the bigger is the size of the visual storyboard and the buffer. The rest of the chain of the algorithm is adapted to the new buffer size.

An embodiment of the method also allows for the automatic selection of the most representative frame or the frame with the highest quality from a number of recurring scenes, as may happen for instance when recording a sports event like biathlon or formula one. Similar image frames or low-quality frames, e.g., blurred or red-eye frames, can be removed from the story board through dedicated filters before they are input into the buffer. By the described method, only the best image frames representing a specific scene, like e.g., a family get-together, may be kept.

In an alternative embodiment, a method for generating a visual story board in real time while recording a video in an image-capturing device including a photo sensor and a buffer may include the following consecutively performed steps:

a) receiving information on an image frame of the video, wherein the information on an image frame includes a semantic description of the data of the image frame;

b) pairwise similarity matching among the semantic descriptions of a plurality of image frames, information on which has previously been stored in the buffer, wherein the similarity matching produces at least one numerical value representing the degree of similarity of the semantic descriptions of the respective pair of image frames;

c) storing the produced at least one numerical value in a similarity matrix, wherein each matrix element (i, j) of the similarity matrix is given by the at least one numerical value resulting from a similarity matching of image frames with list indices i and j selected from an ordered list consisting of the plurality of image frames;

d) determining an image frame with list index k from the ordered list consisting of the plurality of image frames, which, if removed from the similarity matrix, optimizes the similarity matrix according to a pre-determined criterion;

e) replacing the information on the determined image frame with list index k in the buffer by the information on the received image frame.

The above-mentioned steps are largely identical to the steps described earlier with a few exceptions detailed below. As described earlier, an embodiment may further include starting the recording of the video before step a) or finishing the recording of the video after step e).

Other than temporarily extending the similarity matrix to dimension (N+1)×(N+1) by adding the received image frame, the corresponding steps b) to e) of the alternative embodiment perform pairwise similarity matching only among the semantic descriptions of the plurality of image frames, information on which has previously been stored in the buffer, without adding the received image frame, and applies the previously described embodiment of optimizing the similarity matrix by removing the determined image frame with list index k from the similarity matrix of dimension N×N. The information on the received image frame then replaces the information on the determined image frame with list index k, such that the information on the received image frame is unconditionally stored in the buffer, while the buffer maintains its size. Thus, the alternative embodiment can be understood as shrinking the buffer by one buffer frame before adding the information on the received image frame.

Such an approach may be applied if it is determined according to an additional, pre-determined criterion that the information on the received image frame shall be stored in the buffer while the buffer cannot be extended because it has been already filled. This situation may arise in cases when the image-capturing device detects the beginning of a new scene in the recorded video, e.g., by detecting that the recording of the video was resumed, and the first candidate image frame of this new scene shall be stored in the buffer in any case to enter at least one image frame from the new scene into the temporary story board—which is given by the current content of the buffer.

As before, steps a) to e) of the described embodiment may be cyclically performed. The described alternative embodiment may be combined with the previously described embodiments, e.g., by following the steps of the alternative embodiment only under certain conditions, like the detection of a new scene or a completely filled buffer, while else following the steps of one of the previously described embodiments. The same argument holds for the previously described embodiments, which may be combined or alternated according to a pre-determined criterion.

It shall be understood that in any of the above described embodiments, the similarity matrix may also be constructed for a fraction of the buffer only, e.g., by including only a subset of the plurality of image frames into the ordered list. Such a subset can, for instance, be defined by those image frames among the plurality of image frames belonging to one or multiple pre-determined scenes or by those belonging to one recording session, wherein a recording session is given by a part of the video which has been recorded continuously in wall clock time. Particularly, the described embodiments may allow for the generation of a visual story board consisting of several largely independent parts, wherein each part can be generated following some or all of the above-described steps.

In a further embodiment, the selection of the frame to be discarded from the buffer and replaced by another can be done by determining the image frame with list index k from the ordered list which has the lowest quality in terms of a quality measure such as, e.g., sharpness, contrast, color monotony, exposure, color saturation, or similar.

In a further embodiment, the selection of the frame to be discarded from the buffer and replaced by another can be done by determining in the similarity matrix the couple of (sparse) frames (not necessarily temporally adjacent) with the shortest computed semantic distance; then, eliminating one frame of the couple. In an embodiment, the similarity matching can include determining a distance measure between the semantic descriptions of the corresponding image frames based on the information about the spatial distribution of at least one color within the image frames. In particular, the distance measure between the semantic descriptions of the corresponding image frames may be a distance measure between the color histograms, more specifically the GLACE histogram representations, of the corresponding image frames. The distance measure may then be determined by using one of the following distances between two vectors, known in the art: generalized Jaccard distance, Minkowski distance, Bhattacharyya distance, Manhattan distance, Mahalanobis distance, Chebyshev distance, Euclidean distance, or similar distances. An embodiment employs the generalized Jaccard distance to determine the distance measure between the GLACE histogram descriptions of the corresponding image frames. The generalized Jaccard distance only uses simple minimum and maximum operations and fast summing operations while avoiding costly multiplications. Since calculating the distance measure is generally the most time-consuming part of the described embodiments besides extracting the semantic description from the image data, employing a computationally cheap distance measure like the generalized Jaccard distance measure significantly speeds up the overall algorithm, thereby facilitating the real-time generation of a visual story board.

According to another embodiment, the step of storing the information on the received image frame in the buffer can include replacing information on at least one image frame among the previously stored information on the plurality of image frames. This can be done by using one of the above described methods employing a similarity matrix or by other means of selecting the image frame among the plurality of image frames whose information shall be replaced in the buffer, either as part of the similarity matching step or by selecting the image frame according to a pre-determined criterion based on, e.g., the quality of the image frame.

Alternatively, the step of storing the information on the received image frame in the buffer can include adding the information to the buffer and, if necessary or decided according to a pre-determined criterion, increasing the size of the buffer. Such an increase in size may be triggered for instance by the detection of a new scene when the buffer is either already completely, or is nearly completely, filled.

In a further embodiment, a method can further include the passing of image data of the received image frame through a filter prior to the step of comparing the information on the received image frame, wherein the filter discards the information on the received image frame depending on a pre-determined criterion. This additional step allows to pre-select image frames in addition to a possible selection according to a sampling rate S_{R} (as described above) in a filtering process based on a pre-determined criterion, such as almost monotone image frames, image frames of bad quality, blurred frames, or similar. Applying the described pre-filtering process can strongly reduce the number of candidate image frames which are considered for becoming part of the generated visual story board. In an embodiment, the pre-filtering process precedes the step of extracting information on the received image frame from the data of the image frame. However, information on the received image frame extracted during the pre-filtering process may become part of the information on the received image frame used in the further steps of an embodiment.

In a particular embodiment, the above-mentioned filter may be a monotone filter, which discards at least one out of the following types of image frames: monotone frames, black frames, fade in/out frames, obscured frames, low-contrast frames, and overexposed frames. The monotone filter may determine whether to discard an image frame based on a luminance histogram of the image data of that frame. Also measures for the overall contrast within an image frame may be used to filter out image frames that are mostly black, faded in or out, or overexposed. A fade in/out of a video may also be directly triggered by a user and thus be directly detected by the image-capturing device.

Whether an image frame is ‘too monotone’ and should be discarded from the key-frame extraction chain strongly depends on the type of content that is recorded by the image-capturing device. For example, different thresholds for determining whether an image frame is ‘too monotone’ apply when recording a night-time video than when recording a video in broad daylight. The same holds when comparing indoor and outdoor videos. Therefore, the pre-determined criterion according to which the filter determines whether an image frame is ‘too monotone’ can be adapted by the image-capturing device based on a detection of the content of the recorded video like the detection of night-time or day-time. An adaptation of the predetermined criterion may for instance become necessary when the user steps out of a cave while recording a video because the ambient light conditions change significantly in the recorded video. Such an adaptation of the predetermined criterion may specifically be carried out automatically by the adaptive monotone filter while recording the video, i.e., in real time. A particular embodiment of an adaptive monotone filter is given by a zero-forcing frame filter. Such a zero-forcing frame filter is computationally cheaper than other methods based on variance since no square roots need be computed, at least in its simplest implementation. The principle is based on the following: if a bin h(j) of the histogram, e.g., a luminance histogram, is below a predetermined threshold, Th_{ZF}, then the bin is forced to zero, i.e., h_{ZF}(j)=0, wherein j is an index representing the bins of the histogram, e.g., luminance levels, else h_{ZF}(j)=h(j).

The new histogram h_{ZF}(j) is then evaluated by counting the number N_{B} of non-null bins. If the number N_{B} of non-null bins is significant, i.e., above a predetermined threshold Th_{N}, then the frame is classified by the filter as not ‘too’ monotone and is passed to the next module of the key-frame extraction chain. Otherwise the frame is discarded because it is considered “too” monotone. As before, the frame itself is not discarded from the video but the information on the frame is discarded from the key-frame extraction chain.

An embodiment of the algorithm of the adaptive monotone filter generally adapts the two thresholds Th_{ZF} and Th_{N} in real time while recording the video. However, in an alternative embodiment three major thresholds can be used to design an adaptive monotone filter based on the zero forcing approach: Th_{ZF1}, Th_{ZF2}, and Th_{N}.

The two thresholds Th_{ZF1} and Th_{ZF2} may be expressed as percentages, i.e., as scalar values in the range [0,1], which are multiplied with a predetermined reference bin height Thₕ to produce the threshold for zero forcing the bins, i.e. Th_{ZF}=Thₕ·Th_{ZF1}, and with the size H of the histogram, i.e., the overall number of bins of the histogram, to produce the threshold for determining whether the frame is ‘too’ monotone, i.e. Th_{N}=H·Th_{ZF2}. If N_{B}<Th_{N}, then the frame is determined as ‘too’ monotone.

Since the content of a recorded video is highly unpredictable and may be strongly varying, both thresholds Th_{ZF1} and Th_{ZF2} may be adapted by the filter based on the pixel contents of the corresponding image frame.

The thresholds may be updated differently for regular or non-regular sampling rates. Although the zero-forcing method does not use the variance of the histogram to determine whether or not the corresponding image frame is ‘too’ monotone, the variance may be used to compute and eventually update the required thresholds for the filter.

In an embodiment, the predetermined thresholds may be fixed, i.e., the filter may be constant in time. The fixed values for Th_{ZF1} and Th_{ZF2} may be defined by the developer or the user or may be based on heuristics averaged over specific databases of video contents. A particular choice for Thₕ may be given by the number Nₚ of pixels in the image frame divided by the number H of bins, corresponding to a simple average luminance.

This variant is very efficient in terms of computational cost and performance. Despite the good performance, however, it does not adapt to the condition of varying ambient light if the video is for instance shot in a garage or at a beach at midday, or if the user shoots the video while moving from an indoor to an outdoor environment. The fixed values for the thresholds may also be used as initial values when starting the recording of a video.

In an alternative embodiment, the threshold Thₕ for determining whether an image frame is ‘too’ monotone or not, may be adapted according to the content of the image frame. In one embodiment, Thₕ may be given by the value of the (unprocessed) histogram in bin number j̅, Thₕ=h( j̅), wherein j̅ is determined by the following weighted average over the normalized histogram h̅(j)=h(j)/Σᵢ₌₁^{H}h(i): j̅=Σⱼ₌₁^{H} j· h̅(j).

Thₕ may be computed first as Nₚ/H because this represents a sort of optimal distribution of the luminance in a frame. It means that all values of luminance are equally present in the frame.

Since the human perception of dark, monotone, and eventually bad image frames which shall be discarded also depends on one or several image frames directly before the corresponding image frame, the threshold Thₕ may be defined as a function of the variance var(j) of the image frame j and h( j̅):

Thₕ=Fₕ(h( j̅),var(j)) Eq. 1

The simplest version is Thₕ=c·h( j̅), where c may dependent, for example, on the variance of the frame:

Thₕ=c(var(j))·h(j) Eq. 2

Given a pseudo Gaussian distribution, if the luminance values are all concentrated around a specific bin (the frame seems to be almost monotone) h(j) will increase while the variance will decrease. Looking at equation 2, in intuitive terms, if the frames are close to monotone, in order to avoid a massive frame discard by the zero forcing filter, Thₕ is balanced down by the factor c, which compensates through smaller values: the bigger the value h(j), the lower the factor c.

The following variants may be employed in embodiments of the adaptive monotone filter:

1. Eq. 2 where c is proportional to the value of the variance var(j).

2. Eq. 2 where c is proportional to a predetermined threshold Thᵥₐᵣ that may be constant or proportional to var(j):

Thₕ=c·Thᵥₐᵣ·h( j̅) Eq. 3

In order to allow adapting the filter to the type of video by considering more frames at once, the threshold Thᵥₐᵣ may be computed for a series of image frames preceding the corresponding image frame in the video:

$${Th}_{var} = k \cdot {\sum }_{i = {N}_{a}}^{{n}_{c}} \frac{( {x}_{i} \cdot {var}_{i} )}{{n}_{c} - {N}_{a}} \qquad Eq . 4$$

where x₁, x₂, . . . xᵢ, . . . x_{N}, may represent a list of coefficients to weight the relative importance of the variances for each frame i and varᵢ is the variance of image frame i. Here Nₐ may be the frame index of an arbitrary image frame, particularly of the image frame at the beginning of a detected new scene, n_{c} may be the index of the current frame, i.e., the corresponding frame which is being processed by the filter.

Using the definition of the threshold Thᵥₐᵣ from Eq. 4, the zero-forcing filter behaves adaptively to the content and adapts the above-mentioned thresholds in real time.

The following variants may be used for the definition of Thᵥₐᵣ:

3. The constant k may be a percentage to scale the threshold Thᵥₐᵣ that is founded on heuristics and is fixed.

4. The constant k may be a percentage to scale the threshold Thᵥₐᵣ as a function Fₖ(varᵢ) that is founded through heuristics. In intuitive terms, for lower values of the variance, thus dark scenes, it is better to have k close to “1”. If the variance is high because the luminances are well distributed, the coefficient k may be smaller. The function Fₖ may have a simple monotonically decreasing shape or any other more complex dependence on the variance of the image frame.

5. Nₐ may be updated with a frequency Upd(Nₐ) that depends on the variation of the variance varᵢ while shooting the video, e.g.:

$$Upd ( {N}_{a} ) = {F}_{upd} ( \frac{d {var}_{i}}{d i} ) \qquad Eq . 5$$

In intuitive terms, the more the ambient light conditions are stable in the video, the less Nₐ needs frequent updates. On the other hand, the more the ambient light conditions change, the more frequent updates are needed. Any monotonically increasing function F_{upd} may be used to reflect the above characteristics.

6. The value of Nₐ may be determined/updated depending on the variation of the variance varᵢ while shooting the video, e.g.:

$${N}_{a} = {F}_{Na} ( \frac{d {var}_{i}}{d i} ) \qquad Eq . 6$$

The functional form of F_{Na} may be chosen in a manner that the more the ambient light conditions are stable in the video, the more Nₐ gets close to the current frame n_{c}.

7. Looking at Eq. 4, it may be that Nₐ is null. In this case Thᵥₐᵣ is nothing but an average of all variances of the video sequence until the current frame n_{c}.

8. Looking at Eq. 4, it may also be that Nₐ=n_{c}−N where N is a fixed integer determined by the developer, and xᵢ=1/N is a constant. In this case Thᵥₐᵣ is nothing but a moving average over those N image frames in the video sequence just before the current frame n_{c}.

9. As above, but xᵢ may be a non-constant value. In this case the list of coefficients xᵢ may be determined by the developer. The only constraint is that

$${\sum }_{i}^{N} {x}_{i} = 1 \qquad Eq . 7$$

In this case Thᵥₐᵣ is a weighted moving average over those N image frames in the video sequence just before the current frame n_{c}.

10. Generally, any type of curve profile for the list of xᵢ coefficients may be chosen. Therefore xᵢ=Fₓ(i), where Fₓ is compliant with Eq. 7, may be chosen. In mathematical terms that would mean that Fₓ may be a probability distribution function according to the following equation:

∫ᵢFₓ(i)di=1 Eq. 8

The threshold Thᵥₐᵣ may then be chosen as follows:

$${Th}_{var} = {\sum }_{i = {N}_{a}}^{{n}_{c}} {F}_{x} ( i ) \cdot {var}_{i} \qquad Eq . 9$$

11. In case of frame regular sub sampling, the sums of Eq. 4 and related equations may be taken only over the sub-sampling frames, i.e., skip frames recorded in the video for better performance. By employing the sample parameter S_{R} for the inverse sampling rate of the frames inside the whole key-frame extraction chain, the threshold Thᵥₐᵣ may be calculated as:

$${Th}_{var} = {\sum }_{i = {N}_{a} + s \cdot {S}_{R}}^{{n}_{c}} {F}_{x} ( i ) \cdot {var}_{i} \\ s = 0 , 1 , 2 … \qquad Eq . 10$$

12. In case of non-regular sub sampling, the inverse sampling parameter S_{R} turns into a function F_{SR} (s), with s=0, 1, 2, . . . Particular variants for F_{SR} (s) may be:
a. Any function of

$$\frac{d {F}_{2} ( i )}{d i} ,$$

where F₂(i) is a differentiable function of the frame index i. For example, if the curve F₂ changes faster, the derivative increases and the algorithm increases the sub-sampling rate of the coefficients, depending on the shape of the chosen function F₂.
b. Motion estimation data to estimate either the movement of the hand while shooting or the luminance change in the scene. If the trend of the Global Motion estimation changes faster, thus the derivative increases and the algorithm may increase or decrease the sub-sampling rate of the coefficients.
c. Gyroscope data to estimate either the movement of the hand while shooting or the luminance change in the scene. If the trend of the Gyroscope amount of direction changes increases faster, thus the derivative increases and the algorithm may increase or decrease the sub-sampling rate of the coefficients.
d. Accelerometers data to estimate either the movement of the hand while shooting or the luminance change in the scene. If the trend of the Accelerometers amount of direction changes increases faster, thus the derivative increases and the algorithm may increase or decrease the sub-sampling rate of the coefficients.
e. Battery Level.
   i. If the battery level is too low, the sampling rate may be decreased and vice versa if the battery level is high.
   ii. Additionally, if the trend of the Accelerometers amount of direction changes increases faster, thus the derivative increases and the algorithm may increase or decrease the sub-sampling rate of the coefficients.

13. Given a set of stored variances varₐ, it is possible to concentrate the selection where

$$\vert \frac{d {var}_{i}}{d i} \vert$$

is higher. In intuitive terms, it is reasonable to concentrate the comparison between frames when light conditions are changing than when the light conditions are stable.

14. The parameter Nₐ in Eq. 4 and derived equations may be a variable parameter that may be adapted by the system to consider a greater number of coefficients when computing the threshold Thᵥₐᵣ. Nₐ may be defined by a function of a list of variables Nₐ=F₃(var₁, var₂, . . . , var_{N}). The following variable list may be chosen:
a. Motion-estimation data to estimate either the movement of the hand while shooting or the luminance change in a scene;
b. Gyroscope data to estimate either the movement of the hand while shooting or the luminance change in a scene;
c. Accelerometer data to estimate either the movement of the hand while shooting or the luminance change in a scene;
d. Battery level.

15. Other semantic engines that may provide important information about scene tagging may be considered in order to stop adaptation of the thresholds and to restart all trend computations. In particular that may be done by setting Nₐ to an image frame where a scene change has been detected.

16. If scene-detection algorithms are being used, then Thᵥₐᵣ may be computed hierarchically. First Thᵥₐᵣ is averaged for each scene, then Thᵥₐᵣ is averaged over all available scenes.

17. As in Eq. 9 and derived equations, but the distribution function assigns an importance score, then the threshold Thᵥₐᵣ is computed through a weighted average over all the scenes.

18. As above, where the distribution function is dependent on the number of detected faces in each scene. The higher the number of faces, the higher the score, the higher the weight when computing the Thᵥₐᵣ.

19. All above variants may be chosen after selecting a predefined rectangular Region Of Interest and carrying out the corresponding analysis in the selected region.

20. All above variants may be chosen after applying a saliency model algorithm in order to detect a non-rectangular Region Of Interest for each frame and carrying out the corresponding analysis in the detected region.

21. All variants 3-20 where the Median is performed instead of the Average of the Variance among a set of frames.

22. All variants 3-20 where the Mode is performed instead of the Average of the Variance among a set of frames.

Instead of forming the average, it is also possible to compute Thᵥₐᵣ through a function F₁ applied to the variances of the last frames:

Thᵥₐᵣ=F₁(varᵢ) Eq. 11

As the function F₁ indicates the new threshold, in mathematical terms that would be:

$${Th}_{var} = k \cdot {max}_{i} ( {var}_{i} ) , \\ where \\ {N}_{a} < i < {n}_{c} \qquad Eq . 12$$

The following variants may be chosen:

23. It may be Nₐ=n_{c}−N, where Nₐ is null. In this case Thᵥₐᵣ is the maximum of all variances of the video sequence until the current frame n_{c}.

24. It may be Nₐ=n_{c}−N, where N is a fixed integer predetermined by the developer based on heuristics. In this case Thᵥₐᵣ is a moving maximum over the last N image frames of the video sequence until the current frame n_{c}.

25. The constant k may be a percentage to scale the threshold

$$( {max}_{i} ) ( {var}_{i} )$$

(varᵢ) which is found through heuristics and is fixed.

26. The constant k may be a percentage to scale the threshold

$${{max}_{i}}^{( {var}_{i} )}$$

(varᵢ) as a function Fₖ(varᵢ) that is found through heuristics. In intuitive terms, for lower values of the variance, thus dark scenes, it is better to choose k close to “1”. If the variance is high because the luminances are well distributed, the coefficient k may be smaller. Any kind of curve profiles Fₖ, particularly monotonically increasing profiles, may be chosen.

Th_{ZF2} typically cannot be dependent on H because it is a percentage threshold. But it can be dependent on a threshold of variance Thᵥₐᵣ. In general terms, if varᵢ is very small, then it may be better to compensate the filter behavior by a smaller Th_{ZF2}. The same functional dependencies as for Thₕ are also possible for Th_{ZF2}, e.g.:

Th_{ZF}_{₂}=d·Thᵥₐᵣ·h( j̅) Eq. 13

In order to have more degrees of adaptability of the monotone frame filter, the following variants are imaginable:

27. All points 3-26 applied to Th_{ZF}_{₂}.

28. The possibility to establish a functional dependency Th_{ZF2}=F(Th_{ZF1}).

In a further particular embodiment, the above-mentioned filter may be a semantic quality filter which determines the quality of an image frame based on a low-level analysis of the image data of the image frame or high-level metadata or tags produced by Artificial Intelligence algorithms (in a particular case, but not limited to, the Face Detection algorithm outputs the number of faces, width/height/position of each face in each frame that can be used as well with a low-level descriptor to define a measure of quality perceived). In a particular case, the semantic quality filter may be a blurring frame filter which discards the received image frame from the key-frame extraction chain, if the blurring of the received image frame exceeds a pre-determined value. The blurring or sharpness of an image frame may be determined by frequency analysis of its image data, where the sharpness is highest if the contribution of the high frequencies is strongest in the resulting spectrum. As with the monotone filter above, the pre-determined thresholds according to which the blurring frame filter decides whether a frame is blurred too much and shall be discarded from the chain may be adapted by the image-capturing device based on a detection of the content of the recorded video.

In an embodiment, the semantic quality filter or blurring frame filter may be an adaptive semantic quality filter which determines a quality score through the computation of the sharpness of the corresponding image frame or a set of image frames depending on the content of a video sequence. In particular, a measure for the sharpness may be extracted with the aim to assign a quality score to the corresponding image frame and to assess whether the image frame is too blurred or less blurred than other image frames. Such a measure may be adapted depending on the type of content of the recorded video.

The blurring frame filter may compute a quality threshold Th_{B} for the sharpness of an image frame based on frequency analysis that determines whether the image frame has a good quality and is passed on in the key-frame extraction chain or has a bad quality and is discarded from the key-frame extraction chain.

The blurring frame filter may compute the sharpness of an image frame based on an algorithm which is based on the Frequency Selective Weighted Median (FSWM) of the image data p[i,j], wherein p[i,j] may be the luminance, a color value, or a combination of color values of the pixel at line i and column j of the image frame.

The FSWM measure of a pixel p[i,j] uses a cross-like configuration of pixels around i,j and is computed as follows:
Horizontal direction:
   medh₁=median(p[i,j−2],p[i,j−1],p[i,j])
   medh₂=median(p[i,j],p[i,j+1],p[i,j+2])=
   M₁(i,j)=medh₁−medh₂
Vertical direction:
   medv₁=median(p[i−2,j],p[i−1,j],p[i,j])
   medv₂=median(p[i,j],p[i+1,j],p[i+2,j])
   M₂(i,j)=medv₁−medv₂
FSWM measure:

FSWM(i,j)=M₁(i,j)²+M₂(i,j)² Eq. 14

The sharpness of an image frame based on the FSWM measure may then be defined as the following sum:

$${Sharpness}_{FSWM} = \frac{{\sum }_{i = 0}^{N} {\sum }_{j = 0}^{M} FSWM ( i , j ) : FSWM ( i , j ) > {T}_{F}}{\# FSWM ( i , j ) : FSWM ( i , j ) > {T}_{F}} \qquad Eq . 15$$

Here T_{F} is an optional parameter used to avoid considering extremely low values of the FSWM measure which usually correspond to noise.

The adaptive semantic quality filter or blurring frame filter may determine whether an image frame is too blurred based on its level of Sharpness_{FSWM}, in the following Sᵢ=Sharpness_{FSWM} of the image frame with index i.

In general, the blurring filter may compare the sharpness Sᵢ of the image frame i with a predetermined threshold Thₛ to determine whether the image frame is sharp enough, i.e., not too blurred, or not:

Sᵢ>k Thₛ Eq. 16

Here k may be a percentage scale factor, i.e., 0<k<1, which may be constant. The threshold Thₛ may be a fixed parameter value which is predetermined by the developer, the user, or the device at the beginning of the shooting session or it can be computed on the run. The latter case allows the blurring frame filter to be adapted to the content of the currently recorded video sequence.

The following variants may be employed by the blurring frame filter:

1. The threshold Thₛ may be fixed and predefined by the developer and based on heuristics.

2. The threshold Thₛ may be computed through a function F₁ applied to the calculated sharpness values Sᵢ of a set of frames.

Thₛ=F₁(Sᵢ) Eq. 17

The following function types may be chosen:

1. Average;

2. Median or Mode;

3. Maximum;

For a blurring frame filter using a function type F₁ based on averaging, the following variants are possible:

The threshold Thₛ for the sharpness of the current frame, with index n_{c}, may be calculated as an average of the sharpness over the last n_{c}−Nₐ image frames in the video sequence with relative weights xᵢ for each image frame i. Nₐ may be the index of an arbitrary image frame.

$${Th}_{s} = k \cdot {\sum }_{i = {N}_{a}}^{{n}_{c}} \frac{( {x}_{i} \cdot {S}_{i} )}{{n}_{c} - {N}_{a}} \qquad Eq . 18$$

The following variants of the averaging formula Eq. 18 may be conceived:

1. The constant k may be a percentage to scale the threshold Thₛ and is found through heuristics and fixed.

2. The constant k may be a percentage to scale the threshold Thₛ as a function k(Sᵢ) that is found through heuristics. In intuitive terms, for higher values of sharpness, thus for a fixed and stable camera, it is better to have k as a percentage close to “0”, as the average quality of each frame will be pretty high. If the sharpness is lower because the ambient light conditions are poor or the hand holding the camera shakes, the average blurring level will be higher, and k may be closer to “1”. Although the most promising function k(Sᵢ) may be a monotonically decreasing curve, any kind of functional dependence may be chosen.

Nₐ may be updated with a frequency Upd(Nₐ) that depends on the variation of the sharpness Sᵢ while shooting the video, e.g.:

$$Upd ( {N}_{a} ) = {F}_{upd} ( \frac{d {S}_{i}}{d i} ) \qquad Eq . 19$$

In intuitive terms, the more the sharpness value in a video sequence is static or stable, the less frequently Nₐ needs frequent updates. On the other hand, the more the sharpness changes, the more frequently updates are needed.

4. Nₐ may be calculated as a function F_{Na} of the variation of the sharpness Sᵢ while shooting the video, e.g.:

$${N}_{a} = {F}_{Na} ( \frac{d {S}_{i}}{d i} ) \qquad Eq . 20$$

The function F_{Na} may be chosen such that the more the sharpness value is static and stable in the video the more Nₐ gets close to the current frame n_{c}.

5. Looking at Eq. 18, it may be that Nₐ is null. In this case F₁ is nothing but an average of all values of sharpness of the video sequence until the current frame n_{c}.

6. Looking at Eq. 18, it may also be that Nₐ=n_{c}−N, where N is a fixed integer predetermined by the developer, and

$${x}_{i} = \frac{1}{N}$$

is a constant. In this case F₁ is nothing but a moving average (over N frames) following the video sequence until the current frame n_{c}.

7. As above, but xᵢ may be a non-constant value. In this case the list of coefficients xᵢ may be predetermined by the developer. The only constraint is that

$${\sum }_{i}^{N} {x}_{i} = 1 \qquad Eq . 21$$

In this case F₁ is a weighted moving average of the values of sharpness of the video sequence until the current frame n_{c}.

8. In more general terms, any type of curve profile for the list of xᵢ coefficients xᵢ=Fₓ(i), where Fₓ has to be compliant with Eq. 21, may be chosen. Particularly, F_{X}(i) may be a probability distribution function with the following constraint:

∫ᵢFₓ(i)di=1 Eq. 22

The threshold Thₛ may then be chosen as:

$${Th}_{s} = k \cdot {\sum }_{i = {N}_{a}}^{{n}_{c}} {F}_{x} ( i ) \cdot {S}_{i} \qquad Eq . 23$$

The function Fₓ may have any shape.

9. In case of frame regular sub sampling, the sums in Eq. 18 and related equations may be taken only over the sub sampling frames, i.e., skip frames recorded in the video for better performance. By employing the sample parameter S_{R} for the inverse sampling rate of the frames inside the whole key-frame extraction chain, the threshold Thₛ may be calculated as:

$${Th}_{s} = k \cdot {\sum }_{i = {N}_{a} + j \cdot {S}_{R}}^{{n}_{c}} {F}_{x} ( i ) \cdot {S}_{i} \\ j = 0 , 1 , 2 … \qquad Eq . 24$$

10. In case of non-regular sub sampling, the inverse sampling parameter S_{R} may turn into a function F_{SR} (j), with j=0, 1, 2, . . . Particular variants for F_{SR} (j) may be:
a. Any function of

$$\frac{d {F}_{2} ( i )}{d i} ,$$

where F₂(i) is a differentiable function of the frame index i. For example, if the curve F₂ changes faster, the derivative increases and the algorithm increases the sub sampling rate of the coefficients, depending on the shape of the chosen function F₂.
b. Motion estimation data to estimate either the movement of the hand while shooting or the luminance change in the scene. If the trend of the Global Motion estimation changes faster, thus the derivative increases and the algorithm may increase or decrease the sub-sampling rate of the coefficients.
c. Gyroscope data to estimate either the movement of the hand while shooting or the luminance change in the scene. If the trend of the Gyroscope amount of direction changes increases faster, thus the derivative increases and the algorithm may increase or decrease the sub sampling rate of the coefficients.
d. Accelerometers data to estimate either the movement of the hand while shooting or the luminance change in the scene. If the trend of the accelerometers amount of changes of direction varies faster, thus the derivative over time increases or decreases, the algorithm, respectively, may increase or decrease the sub-sampling rate of the coefficients.
e. Battery Level.
   i. If the battery level is too low, then the sampling rate may be decreased and vice-versa if the battery level is high.
   ii. Additionally, if the trend of the accelerometers amount of changes of direction varies faster, thus the derivative over time increases or decreases, the algorithm, respectively, may increase or decrease the sub-sampling rate of the coefficients.

11. Given a set of stored sharpness values Sᵢ, it is possible to concentrate the selection where the

$$\vert \frac{d {S}_{i}}{d i} \vert$$

is higher. In intuitive terms, it is reasonable to concentrate on the comparison between frames when conditions are changing rather than when conditions are stable.

12. The parameter Nₐ in Eq. 18 may be a variable parameter that may change such that a larger number of image frames are considered to compute the threshold Thₛ. Nₐ may be given by a predetermined function of a list of variables, like Nₐ=F₃(S₁, S₂, . . . , S_{N}). The following variable list may be chosen:
a. Motion-estimation data to estimate either the movement of the hand while shooting or the luminance change in the scene;
b. Gyroscope data to estimate either the movement of the hand while shooting or the luminance change in the scene;
c. Accelerometer data to estimate either the movement of the hand while shooting or the luminance change in the scene;
d. Battery level.

13. Other semantic engines that may provide important information about scene tagging may be considered in order to stop adaptation of the threshold and to restart all trend computations. In particular that may be done by setting Nₐ to an image frame where a scene change has been detected.

14. If scene detection algorithms are being used, then Thₛ may be computed hierarchically. First Thₛ may be averaged for each scene, then Thₛ may be averaged over all the available scenes;

15. As in Eq. 23, but the distribution function assigns an importance score, then the Thₛ is computed through a weighted average over all the scenes;

16. As above, where the distribution function is dependent on the number of detected faces found in each scene. The higher the number of faces, the higher the score, the higher the weight when computing the threshold Thₛ.

17. All above variants may be chosen after selecting a predefined rectangular Region Of Interest and carrying out the corresponding analysis in the selected region.

18. All above variants may be chosen after applying a saliency model algorithm in order to detect a non-rectangular Region Of Interest for each frame and carrying out the corresponding analysis in the detected region.

19. All variants 1-18 where the Median is performed instead of the Average of the sharpness values among a set of frames.

20. All variants 1-18 where the Mode is performed instead of the Average of the sharpness values among a set of frames.

For a blurring frame filter using a function type F₁ in Eq. 17 based on a maximum selection, the threshold Thₛ may be calculated according to the following formula:

$${Th}_{s} = k \cdot ( {max}_{i} ) ( {S}_{i} ) , \\ where \\ {N}_{a} < i < {n}_{c} \qquad Eq . 25$$

The following variants may be chosen:

1. It may be Nₐ=n_{c}−N, where Nₐ is null. In this case Thₛ is nothing but the maximum of all values of sharpness of the video sequence until the current frame n_{c}.

2. It may be Nₐ=n_{c}−N, where N is a fixed integer predetermined by the developer based on heuristics. In this case Thₛ is a moving maximum over the last N image frames of the video sequence until the current frame n_{c}.

3. The constant k may be a percentage to scale the threshold

$${{max}_{i}}^{( {S}_{i} )} ,$$

(Sᵢ), which is found through heuristics and is fixed.

4. The constant k may be a percentage to scale the threshold

$${{max}_{i}}^{( {S}_{i} )}$$

(Sᵢ) as a function k(S₁) that is found through heuristics. In intuitive terms, for higher a value of sharpness, and thus a fixed and stable camera, it may be better to have k as a percentage close to “0”, as the average quality of each frame will be pretty high. If the sharpness is lower because the ambient light conditions are poor or the hand holding the camera shakes, the average blurring level will be higher, and k may be closer to “1”. Although the most promising function k(Sᵢ) may be a monotonically decreasing curve, any kind of functional dependence may be chosen.

5. All other compatible variants as explained in the context of an average based function type F₁ may also be used for the maximum based function type F₁.

6. If scene-detection algorithms are being used, then Thₛ may be computed hierarchically. First Thₛ may be found as the maximum Thₛ for each scene, then Thₛ may be averaged over all the available Thₛ.

7. As above, but where the xᵢ coefficients in a distribution probability function enable the algorithm to assign an importance score to each frame i so that Σᵢ^{N}xᵢ=1, then the Thₛ may be computed through a weighted average over all the scenes.

8. As above, but where the distribution function is dependent on the number of detected faces found in each scene. The higher the number of faces, the higher the score, and the higher the weight when computing the Thₛ.

9. All above variants may be chosen after selecting a predefined rectangular Region Of Interest and carrying out the corresponding analysis in the selected region.

10. All above variants may be chosen after applying a saliency model algorithm in order to detect a non-rectangular Region Of Interest for each frame and carrying out the corresponding analysis in the detected region.

In a further embodiment, the step of finishing the recording of the video may include removing duplicate information on image frames from the information on the plurality of images frames stored in the buffer, wherein the duplicity of the information on two image frames is determined based on at least one pre-determined criterion. The determination of the duplicity of the information on two or a set of image frames and the removal of the information on one of the two or the set of image frames from the buffer may follow any of the above-described algorithms employing similarity matching or a similarity matrix or quality measure determination and comparison. It may, however, employ alternative algorithms like for instance the K-means algorithm known in the art. The at least one pre-determined criterion may be set by the user, the developer, or the image-capturing device and may depend on a detected content of the recorded video. It may be, in particular, adapted to detected features like content, length of the video, number of detected scenes, or detected motion activity. The additional step of removing duplicate information may be particularly useful when generating visual story boards of very short or very homogeneous videos which may be sufficiently represented by a very small number of image frames.

In a particular embodiment, a method for removing duplicate information on image frames may be specialized for user-generated content (UGC) via adapting thresholds for the duplicate removal based on the content of a video. Such an adaptive duplicate removal module may be applied in the same way to summarize photo albums or other types of multi-media content where a summarization can be carried out based on a set of histograms or arrays, where each array refers to a multimedia content. By removing duplicates, i.e., highly similar image frames, the best possible candidates for the final visual story board can be extracted from an initial set of N histograms.

The adaptive duplicate removal (ADR) module may be formed as a chain made of three fundamental blocks. The first operation may consist in finding the best number K of histograms that can summarize the initial set. In order to be driven by a temporal criterion while trying to summarize the video, the ADR module may order all frames in the temporary visual story board buffer temporally over the timeline and then perform similarity matching and store all the distances between temporally adjacent frames. In the above implementation, the story board buffer is filled with GLACE histograms but any type of array may be employed as long as all frames have the same size array representation. In the following it is described how to apply an embodiment in the case of a K-means clustering algorithm. However many algorithms that aim to cluster a set of elements known in the art can be properly adapted to the described scenario.

An embodiment of the clustering K-Means traditional method may be applied to the set of image frames in the buffer, taking as input the number of clusters (K) computed in the previous block and the initial set of centroids. The initial set of centroids can be found through various different criteria as described below.

Finally the summarization may be done by iterating the K-Means algorithm until the histograms mapping position inside each cluster do not change anymore. The histograms, in fact, are treated as points of an N-dimensional space where the clustering operation is executed.

At the end of the shooting session of a video, a temporary SB is available in the buffer. In order to refine the length of the SB, the ADR algorithm may determine the number of clusters before launching the K-Means algorithm. For each cluster one representative frame may be chosen that will be part of the final visual story board.

It may be possible to estimate the number of clusters which can be equivalent to segmenting the video by using a temporal analysis approach. The list of indices of the image frames is put therefore in temporal order. Then the distance between adjacent frames is calculated through one of the above described embodiments. It is possible to define a threshold Thᵥ to segment the video in scenes. A new scene may then be identified when the distance between adjacent frames is above Thᵤ.

The following list of variables/parameters may be defined:
Thᵤ: threshold for detecting a new scene;
Thₐ: threshold addendum to update Thᵥ;
m_{c}: minimum number of clusters;
Nₖ: number of clusters;
Nₛ: number of scenes;
N_{F}: dimension of the buffer, that stores frames, or histograms representations, or both, the dimension of the similarity matrix M_{diff};

The following variants for the ADR algorithm are possible:

1. Thᵥ is fixed and determined through empirical estimation;

2. If all adjacent distances are below the pre-defined value Thᵥ, Thᵥ is decreased by an empirical decimal and finite parameter value Thₐ (for example as Thᵥ+Thₐ) until the number of clusters˜scenes drops below m_{c};

3. Thᵥ is dependent on other types of quality or semantic criteria such as audio peaks, high frequency sounds, speaker detection, crowd noise, or generic audio metadata, then frequency analysis, global motion activity, temporal position, zoom factors, depth map, detected accelerometer activity or activity detected from sensors disposed in the device, or similar, face-detection information (number of faces, position, width/height), face-recognition tags, GPS position tags, or combinations thereof that may define an array of semantic metadata referred to a single frame.

4. Thᵥ=(const·dist_{AVG}), where ‘const’ is a constant percentage, and dist_{AVG} is the average distance of all distances between frames collected in the similarity matrix M_{diff} while updating the buffer;

5. Thᵥ=(const·dist_{AVG}), where ‘const’ is a constant percentage, and dist_{AVG} is the average distance of all distances between adjacent frames collected while shooting the video. In this case the distance, which is progressively updated through average, is computed for each frame;

6. As in point [00200] but in this case the distance, which is progressively updated through average, is computed for each sampled frame with S_{R} being a regular sampling rate;

7. As in point [00200] but in this case the distance, which is progressively updated through average, is computed for each sampled frame with S_{R} being a non-regular sampling rate. The non-regular sampling rate may be a function of time or frame index of any functional form as described earlier;

8. As in point [00199] where dist_{AVG} is among the frames averaged inside the same segmented scene;

9. Thᵥ=F(t), where F(t) is a function of time t of any functional form as described earlier;

10. More generic semantic tags based on scene detection/classification engines may be used that segment the video into a finite Nₛ number of detected (and/or classified) scenes. Then, if Nₛ is below the SB buffer size, Nₖ may be set equal to Nₛ and the estimation based on Thᵥ may be skipped.

It is known that the choice of the initial set of centroids can be a critical step in the K-Means algorithm. K-Means, in fact works by repeating the centroids computation for a number of times X. The number of iterations can be either defined by the developer or just stopped automatically when the difference between the centroids positions at the iteration (i) and the centroids of iteration (i−1) is below a certain threshold which is defined as well by the developer. In any case, the K-Means algorithm starts the iteration with a set of centroids. The pure temporal sampling of a video sequence may not be the best method to summarize a story, because frames can be of bad quality and there is no type of intelligence in the choice of the representative frame. However, as a matter of fact, the temporal sampling extracts frames from different parts of the video and there is a high chance that, N frames together extracted from N different and adjacent (not overlapping) video segments may be reasonably representative in terms of summarization.

The following options for the initial set of Nₖ centroids are possible:

1. The initial set of Nₖ centroids may be chosen among the N_{F} points of the SB buffer in order to respect as much as possible an equidistant temporal criterion based on the absolute temporal position;

2. The initial set of Nₖ centroids may be chosen among the N_{F} points of the SB buffer in order to respect as much as possible an equidistant temporal criterion based on the relative index array position;

3. The initial set of Nₖ centroids among the N_{F} points of the SB buffer may be chosen closest to the (absolute temporal) middle of each identified segmented scene;

4. The initial set of Nₖ centroids among the N_{F} points of the SB buffer may be chosen closest to the (index array position) middle of each identified segmented scene;

5. The initial set of Nₖ centroids among the N_{F} points of the SB buffer may be chosen in terms of global quality score of each identified segmented scene;

6. Points 1-4 where, instead of the temporal criterion, is used another semantic metric measure, which can be either used or not used for the description/definition of the frames in the SB buffer as histograms or semantic arrays, that allows a numeric computation of distance among two frames.

In addition or alternatively, a post-recording step of reducing the buffer size may be part of an embodiment. If the buffer has not been filled up to its size N_{F} at the end of the recording of the video, the buffer size may be reduced to the size which has actually been filled. Furthermore, the buffer size may be reduced to the buffer size N_{F}′ just before the most recent increase in buffer size according to the above-described embodiments. In the case, that information on more image frames than N_{F}′ has been stored in the buffer, the surplus of information on image frames may be removed by either of the following methods: cut-off of the most recently stored buffer frames beyond N_{F}′, removing of the number of surplus buffer frames by stepping through the buffer with a pre-determined step size and removing the buffer frames at the corresponding positions, i.e., according to a sampling position index criterion, removing the surplus buffer frames with the aim to keep the most uniform frame distribution of the remaining key frames on the timeline or per scene, removing the surplus buffer frames by removing the corresponding amount of buffer frames with the lowest quality, determined by one of the previously described criteria, or combinations thereof. The same reduction of the buffer size may be carried out if the desired number of image frames in the generated visual story board has been pre-set to a number smaller than the number of buffer frames in the buffer after finishing the recording of the video. This allows a user to fix a pre-determined length of the visual story board independent of the length of the recorded video or the contents of the video without impairing the ability of the above described methods to generate a representative visual story board.

According to a further embodiment, a method of generating a visual story board in real time can further include outputting the visual story board in the form of image thumbnails of the image frames whose information is retrieved from the buffer after finishing the recording of the video. The outputting of the visual story board can be done in a way that a user can immediately browse through it, store it together with the recorded video or in a separate place on any of the storage means known in the art, or further post-process it by hand, e.g., by deleting single thumbnails from the visual story board. The storing of the visual story board may also be done automatically by the image-capturing device such that the visual story board can be made available at a later time. The visual story board may be stored in the form of the indices of the corresponding image frames or directly in form of the image thumbnails of the corresponding image frames. The image thumbnails may be reduced versions of the image frames, generated from the images frames by any of the known reduction algorithms, or the full image frames and may also include the corresponding metadata. The generated visual story boards may be organized in lists or folders by the image-capturing device or the user himself in order to be easily searchable or browsable.

In an alternative embodiment, a method for generating a visual story board in real time while recording a video in an image-capturing device including a photo sensor and a buffer may include the following consecutively performed steps:

a) sampling an image frame of the video every N recorded image frames of the video, where N is a pre-determined, positive integer number;

b) storing information on the sampled image frame of the video in the buffer;

c) adapting the sampling of step a) by modifying the pre-determined number N, if a pre-defined number M of image frames has been sampled.

As described earlier, an embodiment may further include starting the recording of the video before step a) or finishing the recording of the video after step c).

In an embodiment, a method of comparing the information on image frames involving the similarity matching described above is substituted by a computationally lighter method of a supervised arithmetical temporal sampling. Other modules, which have been described above, as for instance the extraction of information from image frames, the filter modules, the duplicate-removal module, the buffer update in terms of buffer size, the quality filters, and others, may equally be combined with a method of supervised arithmetical temporal sampling, which is described below.

With exception of the supervised arithmetical temporal sampling the above-mentioned steps are largely identical to the steps described earlier with a few exceptions detailed below.

The step of sampling an image frame of the video every N recorded image frames of the video may be carried out by counting the number of recorded image frames from the beginning of the recording of the video, e.g., by assigning an integer index to each recorded image frame representing the number of image frames recorded since the beginning of the recording of the video, and determining how many image frames have been recorded by the image-capturing device since a specific event, e.g., the latest sampling of an image frame, i.e., the beginning of a new series of N recorded image frames. This can be done by counting the number of image frames recorded since the specific event, namely the sampling of an image frame, and resetting the counter every time an image frame is sampled.

The pre-determined positive integer number N may be a power of two. It may further be pre-determined by the user or the manufacturer or set automatically by the image device depending on a detected content of the video. The same options as described above with respect to the sampling rate S_{R} also apply to the pre-determined positive number N or its inverse, the sampling rate S_{N}=1/N.

Every time N image frames have been newly recorded, an image frame of the video is sampled and information on the sampled image frame is stored in the buffer. The information on the sampled image frame may be, in particular, an index, which may be assigned to the image frame by numbering the recorded image frames in ascending order according to the time of their capturing by the photo sensor. By storing the index of the sampled image frame in the buffer instead of storing the complete image frame, memory can be conserved and the algorithm can be made faster and more efficient.

A counter may be used to count the number of image frames which have been sampled since the beginning of the recording of the video. If it is determined that a pre-defined number M of image frames has been sampled, the pre-determined positive number N may be modified to adapt the sampling of image frames from the video. Particularly, the pre-determined number N may be modified by increasing N by adding a pre-defined step size ΔN or by multiplying N with a pre-defined factor. Generally, N is increased when being modified in step d), however, decreasing N, e.g., upon detection of a change of scenery or upon detection of increased levels of motion in the recorded video, may be possible. Particularly, the step sizes ΔN for increasing or decreasing N or the multiplication factor for multiplying N may be adapted according to any of the criteria described above in the context of adapting the sampling rate S_{R}. In addition, N may be adapted based on the detection of a specific content of the recorded video, like face detection, motion detection, etc., or on the detection of the quality of the recorded image frames, e.g., overexposed, obscured, or blurred image frames.

In one further embodiment, the sampling in step c) may be adapted by doubling the pre-determined positive number N.

Adapting the sampling of step a) by increasing the pre-determined positive number N allows restricting the growth of the size of the buffer with time when recording long videos. Since the final length of a video is a priori unknown because it strongly depends on the user, increasing the number N, i.e., decreasing the sampling rate 1/N, reduces the overall number of image frames whose information is stored in the buffer and therefore helps avoiding overlong buffers which would require substantial post-processing when reducing them to a target size, which can for instance be given by a pre-defined target length of the visual story board. Doubling the pre-determined positive number N every time a fixed, pre-defined number M of image frames has been sampled can be used to produce a nearly logarithmic sampling of image frames with respect to time. Experience shows that long amateur videos tend to be generally more homogeneous in terms of the number and the variety of different scenes and are more often defined by the duration of a specific event, e.g., a wedding, a sports match, a concert, or the like, than professional videos, which are mostly defined by edited scenes. Furthermore, potential viewers of amateur videos tend to be mostly interested in the first few minutes of a video, especially when accessing the video online. Therefore, rating the relative importance of image frames early in a video higher than the importance of image frames later in the video, when extracting representative key frames for a visual story board, follows the preferences of both the user and the viewer.

In a further embodiment, the pre-defined number M of image frames may be given by an integer multiple of a pre-determined length of the buffer. As mentioned above, the pre-determined length of the buffer may be a targeted length of the visual story board, pre-set by the user or the manufacturer. In particular, the pre-defined number M may be given by the pre-determined length of the buffer. The pre-determined length of the buffer may particularly be a power of two.

In a further embodiment, the step of adapting the sampling of step a) by modifying the pre-determined number N may additionally include increasing the size of the buffer. Ideally, this may be done in such a way that the buffer is increased by a fixed size every time the sampling is adapted. In a particular embodiment, doubling the pre-determined number N when adapting the sampling may be combined with increasing the size of the buffer by its original size, i.e., its pre-determined size when the recording of the video was started, creating a new block of the buffer, such that each block includes information on the same number of sampled image frames and that each block represents one specific sampling rate 1/N.

According to another embodiment, the step of storing information on the sampled image frame of the video in the buffer may include:

selecting at least one of the image frames whose information has been stored in the buffer based on a pre-determined criterion, and

deleting the information on the selected at least one image frame, if the buffer is full.

With this approach, the size of the buffer can be kept fixed during the recording of the video and may be initially set to a targeted length of the visual story board to be generated.

In a further embodiment, the information on each sampled image frame includes a time stamp representing the time of recording of the respective image frame, and

the selecting of the at least one of the image frames based on the pre-determined criterion includes:

a) detecting a pair of image frames among those image frames whose information has been stored in the buffer such that the absolute difference of their respective time stamps represents a minimum for all possible pairs of image frames among those image frames whose information has been stored in the buffer, and

b) selecting the image frame out of the detected pair of image frames whose time stamp indicates a later time of recording of the respective image frame.

The time stamp representing the time of recording of an image frame may be a wall clock time or the time elapsed since the beginning of the recording of the video. Starting from the beginning of the buffer, absolute differences of the time stamps of the image frames or each possible pair of image frames, particularly of each possible pair of temporally neighboring image frames, may be calculated and compared to detect a pair of image frames among those image frames whose information has been stored in the buffer with the minimum absolute difference. From the detected pair of image frames that image frame may be selected for deletion whose time stamp indicates a later time of recording of the respective image frame.

By always deleting one image frame out of the pair of temporally closest image frames in the buffer when storing information on a newly sampled image frame of the video, it becomes possible to achieve a mostly temporally equidistant distribution of the sampled image frames in the buffer and therefore a close-to-constant temporal sampling in the visual story board (so called pseudo temporal sampling). With increasing duration of the recorded video, more and more of the initially sampled image frames will be deleted from the buffer such that the temporal distance between the remaining, temporally neighboring image approaches the temporal distance between the latest sampled image frames throughout the buffer.

An alternative method of selecting at least one of the image frames whose information has been stored in the buffer for deletion from the buffer may be given by specifying a time interval ΔT_{f} around a sampled image frame whose information has been stored in the buffer and deleting the information on the image frame with a lowest quality score within the specified time interval from the buffer. The quality score may be determined by determining the sharpness of the respective image frame based on a frequency analysis of the corresponding image data or by a detection of a global-motion activity, by detecting which image frame within the time interval is closer to a pre-defined pure arithmetical temporal sampling, by evaluating face-detection or face-recognition tags of the corresponding image frames, by detecting a red-eye feature in the corresponding image frames, or combinations thereof. The time interval may be specified around a single sampled image frame or around every sampled image frame whose information has been stored in the buffer, wherein the quality scores may be compared across different time intervals to select the sampled image frame with the lowest quality. The time interval ΔT_{f} may also vary with the sampled image frame around which it is specified or a pre-determined criterion, e.g., the time of the recording of the sampled image frame. In a particular embodiment, the time interval ΔT_{f} is specified to be larger for sampled image frames recorded later during the recording session.

Employing a method for updating the buffer according to an embodiment of the above-described pseudo-temporal sampling may allow for significantly lowering the computational cost as compared to a similarity matching based approach while still yielding very good performances in terms of the generated visual story boards being perceived by a majority of viewers as sufficient representations of the respective digital videos. An embodiment of pseudo-temporal sampling is particularly interesting for low-cost image-capturing devices or devices with limited battery lifetime but high user demands on battery lifetime, like cell phones, smart phones, and point-and-shoot digital cameras. Also, an embodiment of pseudo-temporal sampling can easily be implemented in existing camera chipsets without adding additional software or hardware.

It shall be understood that a comparison of information on image frames according to the above-described embodiments involving similarity matching may be combined with the described embodiments of supervised arithmetical temporal sampling.

According to an embodiment, a mobile image-capturing device may include a chipset, wherein any of the above embodiments is implemented. By implementing a method for generating a visual story board in the chipset of a mobile image-capturing device, it becomes possible to generate the visual story board of a recorded video in real time, i.e., in such a way, that the visual story board becomes available to the user of the image-capturing device without noticeable delay after finishing the recording of the video. In most cases, the story board will be available even before the flushing of the image frame buffer, which temporarily stores the recorded image frames, to the storage medium and the compression of the video are completed. An event method may, in particular, make use of instruction sets and algorithms which are anyways implemented in the chipset of an image-capturing device, as for instance blurring frame filters, face-detection and identification algorithms, motion-activity detection algorithms, monotone-frame detection algorithms, accelerometer-activity detection algorithms, histogram-extraction algorithms, and the like.

Finally, a computer program product may include one or more computer-readable media having computer-executable instructions for performing the steps of any of the above-described embodiments.

It shall furthermore be understood that any of the above-described pre-determined criteria like, e.g., the sampling rate S_{R}, the step size for the increase of the buffer, the threshold for the similarity matching, the filtering thresholds and so on, may be adapted during the recording of the video by the described methods, e.g., by detection of specific features in the video.

### BRIEF DESCRIPTION OF THE DRAWINGS

Features and exemplary embodiments as well as advantages will be explained in detail with respect to the drawings. It is understood that the described embodiments should not be construed as being limited by the above or following description. It should furthermore be understood that some or all of the features described above and in the following may also be combined in alternative ways.

FIG. 1 shows a sequence of image frames forming a video as a function of the time, according to an embodiment.

FIG. 2 shows a chain of modules for the extraction of key frames from a video with output of frame indices, according to an embodiment.

FIG. 3 shows a size of the story board buffer and the dimension of the similarity matrix as a function of the number of scenes detected in the video, according to an embodiment.

FIG. 4 shows an application of an adaptive monotone filter and an adaptive semantic quality filter as frame filters on a sequence of image frames, according to an embodiment.

FIG. 5 shows a complete chain of modules for the extraction of key frames from a video including the output of quality enhanced thumbnails, according to an embodiment.

FIG. 6 shows a chain of modules for the extraction of key frames from a video following a method of variable temporal sampling (pseudo-temporal sampling), according to an embodiment.

FIG. 7 shows an example of the zero-forcing monotone frame filter with Th_{N}=Th_{ZFN}=4, according to an embodiment.

FIG. 8 shows a cross configuration for pixels used for the computation of the FSWM measure of sharpness, according to an embodiment.

### DETAILED DESCRIPTION

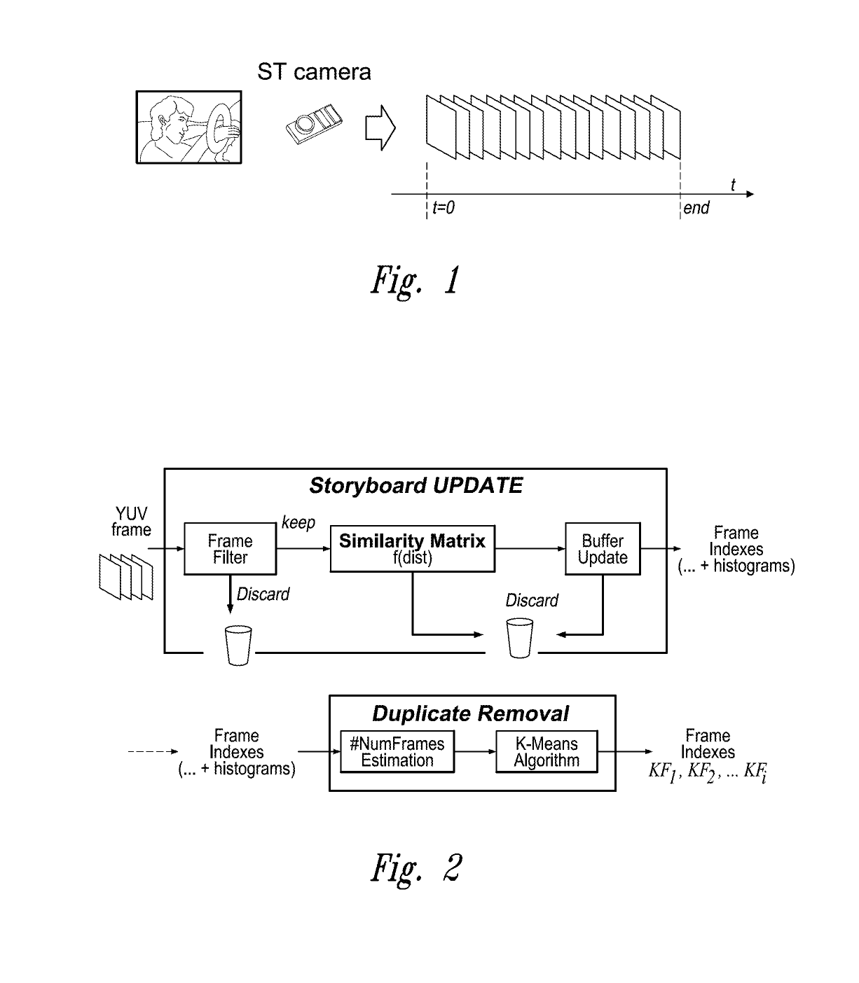

FIG. 1 shows an example for a sequence of image frames recorded by an image-capturing device, here a digital camera or a mobile phone, as a function of the time elapsed since the beginning of the video, i.e., the duration of the video. The darker image frames indicate key frames which have been extracted by an above-described embodiment as image frames for the visual story board. The extraction of key frames from the recorded image frames according to an above-described embodiment is done in real time, i.e., with unnoticeable delay for the user, while the recording of the video is ongoing. Since it often cannot be predicted when the user will stop recording the video, an embodiment of always keeping the (story board) buffer updated with respect to the most recently recorded image frames allows for outputting the generated visual story board right after the user has finished recording the video. In a further embodiment, outputting a preliminary visual story board every time the user interrupts recording the video can be selected by user settings on the image-capturing device.

FIG. 2 shows the chain of modules for the extraction of key frames from a video with output of frame indices according to an embodiment. Not all modules shown are required to realize the extraction of key frames according to one of the above described examples for the herein disclosed methods.

After the processing in the photo sensor, each image frame is generally temporarily available in a dedicated image-frame buffer of the image-capturing device from where it is retrieved for further processing and storage in a video file. According to an embodiment, the image frame is passed from the image-frame buffer to the described key-frame extraction (KFE) algorithm.

After an optional pre-selection of image frames, e.g., according to a pre-determined sampling rate S_{R} as described above, the image frames may be passed through a frame filter which determines according to an above-described embodiment whether the image frame is a good-quality candidate image frame for the visual story board, i.e., a key frame, or a bad-quality frame which is not further processed. It may be noted here that the key-frame extraction chain does not affect in any way which image frames are part of the actual recorded video, but only determines which image frames are key frames for the visual story board. Thus, if an algorithm according to an embodiment ‘discards’ an image frame from the key-frame extraction chain, it is not discarded from the video as well.

An embodiment extracts the above-described information from an image frame before or after passing through the frame filter (extraction module not shown). Information extracted by the frame filter may also be re-used in the further processing. The candidate image frames of good quality are passed to the story board update part of the algorithm, which updates the buffer (the story-board buffer) in which the information of the current set of key frames is stored. Following an above-described embodiment, a similarity matrix may be calculated and the buffer updated by replacing, deleting, or adding information on candidate key frames. Without limitation, the frame indices are finally passed to a module for duplicate removal when the recording of the video has been finished, which may reduce the size of the buffer and remove duplicates, e.g., employing the K-means algorithm.

In an embodiment, only the indices and the associated information on the corresponding image frames, including the semantic description, are stored in the buffer and passed between modules, as shown in FIG. 2. Other embodiments may choose to store the entire image frame or a reduced thumbnail version of it together with the corresponding information. The final output from the duplicate-removal module may, therefore, be in the form of indices, thumbnails, or complete image frames or combinations thereof.

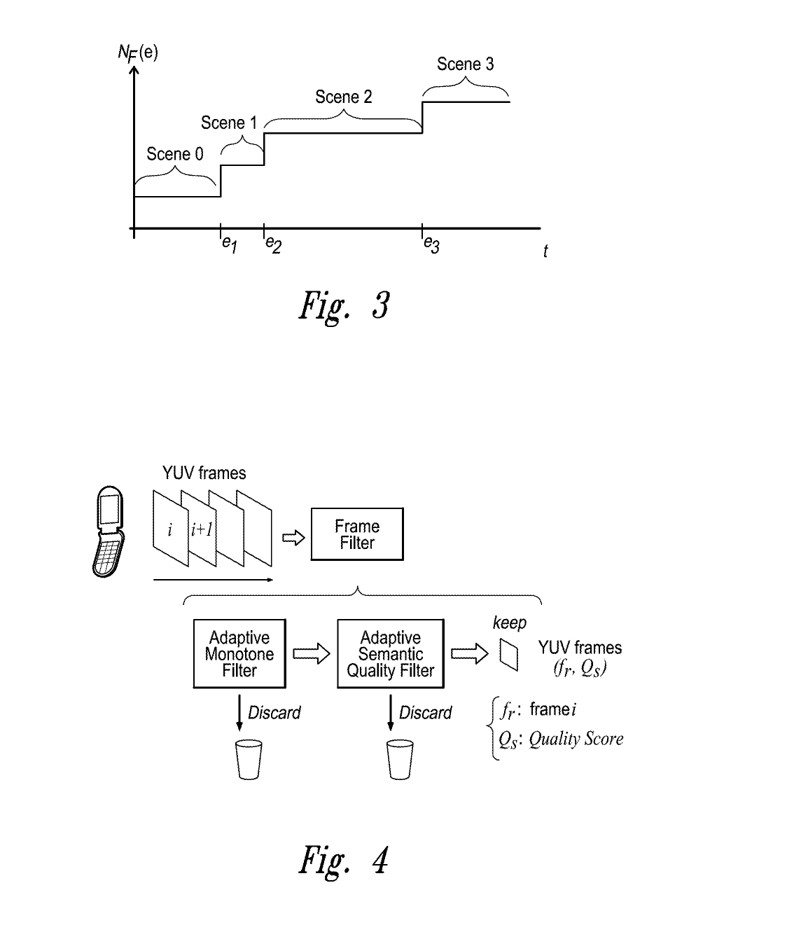

FIG. 3 shows an embodiment of the above-described adaptation of the size N_{F} of the (story board) buffer and the corresponding dimension of the similarity matrix depending on the number of scenes detected in the video. With each scene detected, marked by an event eᵢ on the time axis, the size of the buffer is increased by a pre-determined step. The step size may be constant as shown or dependent on additional parameters like a content detection of the video. The figure demonstrates the particular situation where the number of extracted key frames per scene varies significantly with the corresponding scene, due to the unpredictable nature of the various scenes and the recording style of the user. While an embodiment may aim at a mostly homogeneous distribution of the extracted key frames within the recorded time period, this unpredictable change of content and recording style can also be accounted for by the algorithm such that in any case a representative visual story board becomes available at the end of the recording session.

FIG. 4 depicts a particular implementation of a frame filter according to an embodiment. The recorded image frames are passed, after possible pre-filtering or information extraction, to an adaptive monotone filter, which discards image frames which are ‘too monotone’ according to an above-described criteria, and then to an adaptive semantic-quality filter, which discards images frames with ‘too low quality’ according to an above-described criteria. The image frames kept by the frame filter are passed on as good-quality candidate frames together with an optional quality score as part of the information on the image frame.

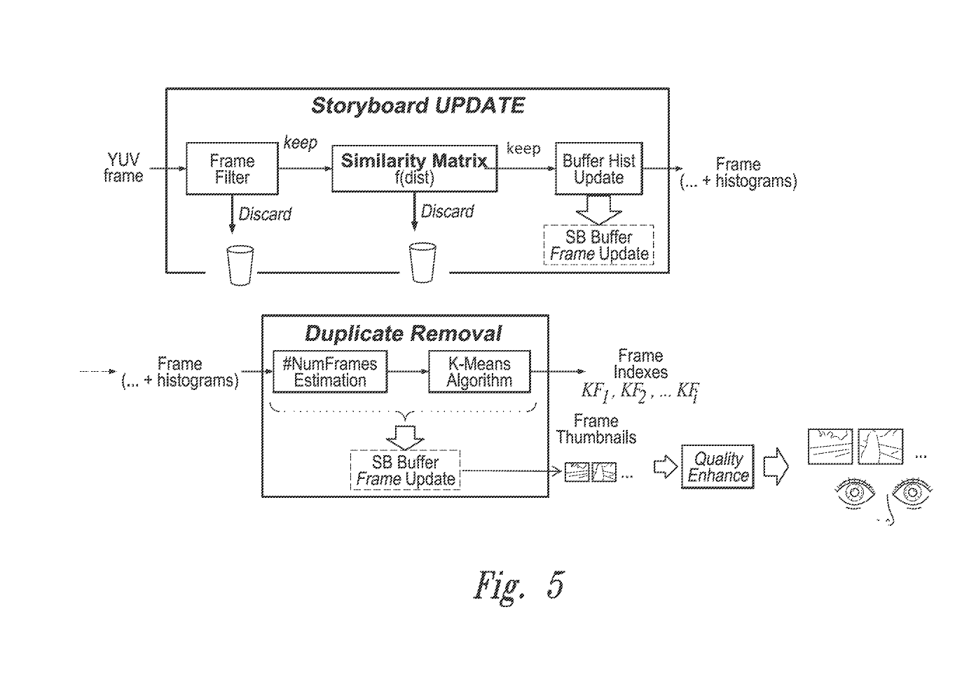

FIG. 5 shows the complete chain of modules for the extraction of key frames from a video including the output of quality enhanced thumbnails, according to an embodiment. In addition to the embodiment shown in FIG. 2, the embodiment of FIG. 5 may contain modules which adapt the size of the (story board) buffer as part of the story board update or the duplicate-removal module (dashed boxes). The generated visual story board may be output in the form of key-frame indices, key-frame thumbnails, or full key frames. Among these options, outputting key-frame indices is the most memory-efficient method since only the key-frame indices need be stored. Both thumbnails and complete image frames may undergo a dedicated quality enhancement at the end of the chain, e.g., by derivative filters, before being displayed on a display device of the image-capturing device or being stored in a memory from which the user may retrieve them at a later time.

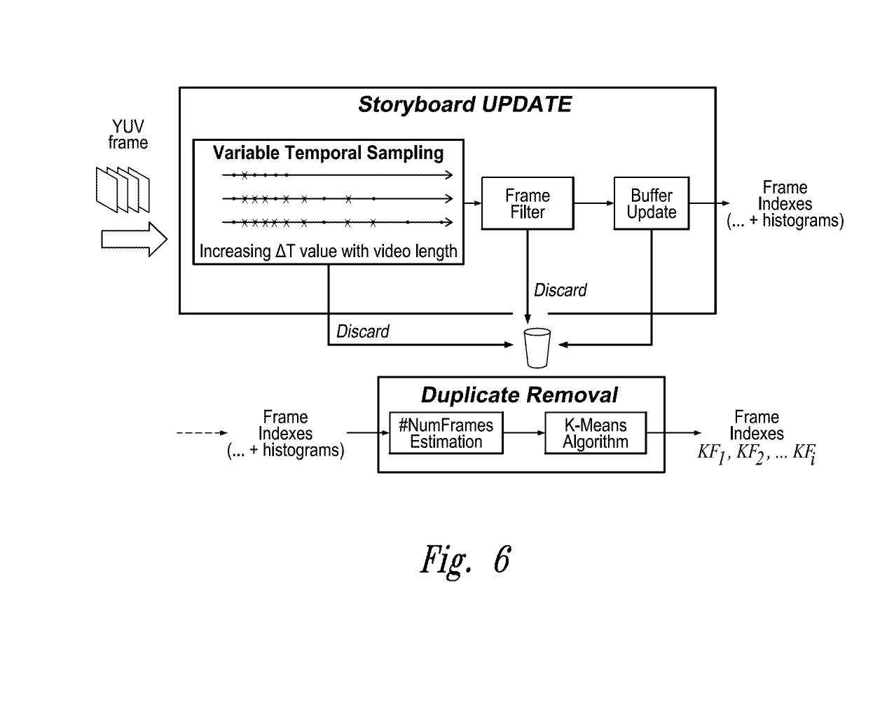

FIG. 6 shows the chain of modules for the extraction of key frames from a video using the method of pseudo-temporal sampling according to one of the above described embodiments. The module for the variable temporal sampling may be placed before the image-frame filter or after it. Placing the module for the variable temporal sampling after the image-frame filter may significantly increase the number of image frames which pass through the image-frame filter, thereby increasing the computational cost significantly. However, a simple pre-filter process placed before the variable temporal sampling may also help to remove candidate image frames early on in the chain.

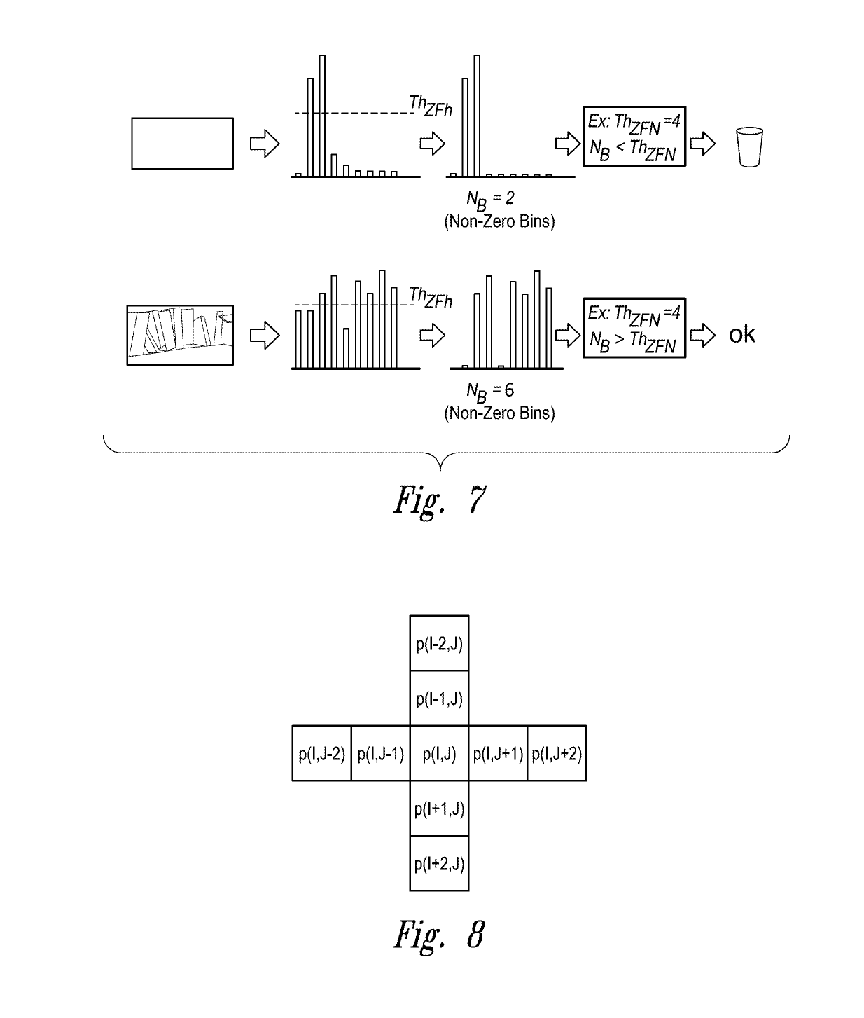

FIG. 7 shows an example for a zero-forcing monotone frame filter with Th_{N}=Th_{ZFN}=4. If the number N_{B} of non-zero bins of the luminance histogram is less than the threshold Th_{N} (see upper row), the image frame is discarded from the key-frame extraction chain and not considered any further. If the number N_{B} of non-zero bins is larger than or equal to the threshold Th_{N} (see lower row), then the image frame is passed on to the next module in the key-frame extraction chain. The image frame in the upper row is a dark frame with N_{B}=2, i.e., ‘too’ monotone, while the image frame in the lower row is a standard frame with N_{B}=6, i.e., a good-quality frame.

FIG. 8 shows the cross configuration used for the FSWM (Frequency Selective Weighted Median) calculation of the sharpness of a pixel p(i, j) in line i and column j of the image frame. To calculate the FSWM sharpness of the pixel, the neighboring two pixels in each direction (up, down, left, right) from the pixel are taken into account. For pixels p(i, j) at the border of an image frame, the missing neighboring pixels may be set equal to the pixel at the border, e.g., p(i, N+1)=p(i, N) where N is the number of pixels in each line of the image frame.

Referring to FIGS. 1-8, the image-capture device may include computing circuitry that performs one or more of above-described functions in hardware, firmware, software, or a combination of subcombination of hardware, firmware, and software. Furthermore, the image-capture device may be coupled to another system, such as a computer system, and some or all of the above-described functions may be performed by the other system.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1-23. (canceled)

24. A method, comprising:
comparing first information describing an image of a stream of video images with second information stored in a buffer and describing at least one other image of the stream of video images, the at least one other image forming at least a portion of a version of a visual story board of the stream of video images; and
storing in the buffer the first information if a result of the comparing meets a criterion.

25. The method of claim 24, wherein:
comparing the first information with the second information includes determining a level of similarity between the first information and second information; and
the result of the comparing meets the criterion if the level of similarity is less than a threshold level of similarity.

26. The method of claim 24 wherein the first information and second information include respective semantic information.

27. The method of claim 24 wherein the version of the visual story board of the stream of images exists at a time of the comparing.

28. The method of claim 24, further comprising not storing in the buffer the first information if the first information does not meet the criterion.

29. The method of claim 24, further comprising:
filtering the image;
comparing the first information with the second information only if a result of the filtering meets a criterion.

30. The method of claim 24, further comprising deleting from the buffer information describing at least one image of the at least one other image of the stream of video images if the result of the comparing meets the criterion.

31. The method of claim 24, further comprising storing in the buffer and associating with the first information an identifier of the image if the result of the comparing meets the criterion.

32. The method of claim 24, further comprising generating the first information in response to the image.

33. An apparatus, comprising:
a visual-story-board buffer; and
a comparator module configured
to compare first information describing a first image of a stream of video images with second information stored in the buffer and describing at least one second image of the stream of video images, and
to store in the buffer the first information if a result of the comparing meets a criterion.

34. The apparatus of claim 33, further comprising an image-capture module coupled to the buffer and configured to capture the first image after capturing the at least one second image.

35. The apparatus of claim 33, further comprising:
an image-capture module coupled to the buffer and configured to capture the first image and the at least one second image; and
wherein the comparator module is configured to compare the first information with the second information while the image-capture module is capturing at least one third image.

36. The apparatus of claim 33, further comprising a removal module configured:
to compare third information describing a third image stored in the buffer with fourth information describing at least one fourth image stored in the buffer; and
to remove at least one of the third information and fourth information from the buffer if a result of comparing the third information with the fourth information meets a criterion.

37. The apparatus of claim 33, further comprising:
at least one integrated circuit; and
wherein at least one of the buffer and comparator module is disposed on the at least one integrated circuit.

38. The apparatus of claim 37 wherein the at least one integrated circuit includes a microprocessor or microcontroller.

39. A tangible, non-transient computer-readable medium storing instructions that, when executed by a computing apparatus, cause the computing apparatus, or an apparatus under control for the computing apparatus:
to compare first information describing an image of a stream of video images with second information stored in a buffer and describing at least one other image of the stream of video images, the at least one other image forming at least a portion of a version of a visual story board of the stream of video images; and
to store in the buffer the first information if a result of the comparing meets a criterion.

40. A method, comprising:
selecting a respective image of a stream of video images at each of one or more selecting times that occur at a selecting rate;
storing in a buffer respective information describing at least one of the selected images, the at least one selected image forming at least a portion of a version of a visual story board of the stream of video images; and
altering the selecting rate in response to selecting a number of the images.

41. The method of claim 40 wherein the selecting rate is constant.

42. The method of claim 40 wherein storing the information in the buffer includes storing the information in the buffer only if the buffer is not full.

43. The method of claim 40 wherein altering the selecting rate includes reducing the selecting rate.

44. The method of claim 40, further comprising, if the buffer is full:
determining information that describes at least one of the selected images and that meets a criterion; and
deleting the determined information from the buffer.

45. An apparatus, comprising:
a visual-story-board buffer;
a selector module configured
to select a respective image of a stream of video images at each of one or more selecting times that occur at a selecting rate, and
to store in the buffer respective information describing at least one of the selected images; and
a rate module configured to adjust the selecting rate in response to the selector module selecting a number of the images.

46. The apparatus of claim 45, further comprising an image-capture module coupled to the buffer and configured to capture sequentially the video images of the stream.

47. The apparatus of claim 45, further comprising:
an image-capture module coupled to the buffer and configured to capture sequentially the video images of the stream; and
wherein the selector module is configured to select the respective image and to store the respective information in the buffer while the image-capture module is capturing at least one of the video images of the stream.

48. A tangible, non-transient computer-readable medium storing instructions that, when executed by a computing apparatus, cause the computing apparatus, or an apparatus under control for the computing apparatus:
to select a respective image of a stream of video images at each of one or more selecting times that occur at a selecting rate;
to store in a buffer respective information describing at least one of the selected images, the at least one selected image forming at least a portion of a version of a visual story board of the stream of video images; and
to alter the selecting rate in response to selecting a number of the images.
